(19) United States
(12) Patent Application Publication
(10) Pub. No.: US 2026/0343166 A1
(43) Pub. Date: Oct. 29, 2026

(54) METHOD AND SYSTEM FOR PROVIDING SPATIAL SOUND PRODUCTION TOOLS

(71) Applicant: Dan Mapes-Riordan Consulting, Inc., Wilmette, IL (US)

(72) Inventor: Daniel Riordan, Wilmette, IL (US)

(21) Appl. No.: 19/657,484

(22) Filed: Apr. 24, 2026

Related U.S. Application Data
(60) Provisional application No. 63/794,509, filed on Apr. 25, 2025.

(51) Int. Cl. H04S 7/00

(52) U.S. Cl. CPC H04S 7/302; H04S 2400/13; H04S 2400/15

(57) ABSTRACT

Systems and methods for providing spatial sound production tools operable to generate dynamically moving sounds are provided. The method includes receiving, by at least one processor of an audio processing system, an audio signal. The method includes receiving, by the at least one processor, a user input defining input parameters of audio motion descriptors. The method includes processing, by the at least one processor, the input parameters of the audio motion descriptors to generate a trajectory signal in time synchronization with the audio signal. The trajectory signal defines position information in spherical polar coordinates over time. The method includes rendering, by the at least one processor, the audio signal based on the trajectory signal to generate a rendered audio signal. The method includes outputting, by a sound system, the rendered audio signal as sound.

### CROSS-REFERENCE TO RELATED APPLICATIONS/INCORPORATION BY REFERENCE

The present application claims priority under 35 U.S.C. § 119(e) to provisional application Ser. No. 63/794,509 filed on Apr. 25, 2025, entitled “METHOD AND SYSTEM FOR PROVIDING SPATIAL SOUND PRODUCTION TOOLS.” The above referenced application is hereby incorporated herein by reference in its entirety.
WEST, J.R., “Five-Channel Panning Laws: An Analytical and Experimental Comparison,” Master's Thesis, Music Engineering, University of Miami, Spring 1998, 150 pages, which is incorporated by reference herein in its entirety.
PULKKI, Ville, “Virtual Sound Source Positioning Using Vector Base Amplitude Panning,” J. Audio Eng. Soc., Vol. 45, No. 6, pp. 456-466 (1997 June), which is incorporated by reference herein in its entirety.
GERZON, Michael A., “Periphony: With-Height Sound Reproduction,” J. Audio Eng. Soc., 1973, 21(1), pp. 2-10, which is incorporated by reference herein in its entirety.
BERKHOUT, A. J., “A Holographic Approach to Acoustic Control,” J. Audo Eng. Soc., Vol. 36, No. 12, December 1988, pp. 977-995, which is incorporated by reference herein in its entirety.
NIXON, Thomas, et al., “Developing a Binaural Renderer for Audio Definition Model Content,” Audio Engineering Society, 152nd Convention Preprint 668, May 2022, pp. 1-5, which is incorporated by reference herein in its entirety.
Digital Cinema Report, June 25, 2019, “DTS: X: The immersive audio standard, explained,” CNET, Sept. 26, 2016, https://www.cnet.com/tech/home-entertainment/dts-x-the-dolby-atmos-alternative-explained, 3 pages, which is incorporated by reference herein in its entirety.
BLEIDT, R. L., et al., “Development of the MPEG-H TV Audio System for ATSC 3.0,” IEEE Transactions on Broadcasting, Vol. 63, No. 1, March 2017, pp. 202-236, which is incorporated by reference herein in its entirety.
KENDALL, G.S., “The Decorrelation of Audio Signals and Its Impact on Spatial Imagery,” Computer Music Journal, Vol. 19, No. 4, pp. 71-87, (1995), which is incorporated by reference herein in its entirety.

### FIELD

Certain embodiments relate to spatial sound production tools. More specifically, certain embodiments relate to a method and system for providing spatial sound production tools operable to generate dynamically moving sounds.

### BACKGROUND

Sound content creation involves capturing, generating, editing, and integrating audio elements into various media. For example, sound content creation may include anything from recording music or voiceovers to adding sound effects and ambient noises to videos or games. A goal of sound content creation is to enhance the overall listening experience and create engaging content. Conventional sound content creation tools are overly simplistic and not particularly compelling. For example, it is common for sound content creators to dynamically pan a sound between two speakers within the industry-standard two-channel stereo format. Two-channel stereo is the norm for traditional music production. In this paradigm, sound objects are panned to a specific position between two speakers. If there is any dynamic movement of the sound object, it is restricted to panning between the speakers. Many artists employ this technique for added stimulation in their music recordings and, in a lesser extent, to live musical performances. However, the net result is a sound image that only moves between two speakers, typically in a simple back and forth manner.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method is disclosed for providing spatial sound production tools operable to generate dynamically moving sounds, substantially as shown in and/or described in connection with at least one of the figures, as set forth more completely in the claims.

These and other advantages, aspects, and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system that is operable to provide spatial sound production tools operable to generate dynamically moving sounds, in accordance with various embodiments.

FIG. 2 is a block diagram of an exemplary spatial sound generator of FIG. 1, in accordance with various embodiments.

FIG. 3 is a block diagram of an exemplary spatial sound generator of FIG. 1 implemented as a digital audio workstation (DAW) plugin, in accordance with various embodiments.

FIG. 4 illustrates a screenshot of exemplary user interface controls for a two-dimensional implementation of a position plugin, in accordance with various embodiments.

FIG. 5A-5B are a flow chart illustrating exemplary steps performed by a trajectory generator for a position plugin, in accordance with various embodiments.

FIG. 6A-6B illustrates exemplary software code for implementing a spatial width function, which corresponds with the spherical polar coordinates over time as output by the trajectory generator of the spatial sound generator, in accordance with various embodiments.

FIG. 7 illustrates a screenshot of exemplary user interface controls for a two-dimensional implementation of a twirl plugin, in accordance with various embodiments.

FIG. 8A-8C are a flow chart illustrating exemplary steps performed by a trajectory generator for a twirl plugin, in accordance with various embodiments.

FIG. 9 illustrates a screenshot of exemplary user interface controls for a two-dimensional implementation of a surf plugin, in accordance with various embodiments.

FIG. 10A-10C are a flow chart illustrating exemplary steps performed by a trajectory generator for a surf plugin, in accordance with various embodiments.

FIG. 11 illustrates a screenshot of exemplary user interface controls for a two-dimensional implementation of a ping pong plugin, in accordance with various embodiments.

FIG. 12A-12F are a flow chart illustrating exemplary steps performed by a trajectory generator for a ping pong plugin, in accordance with various embodiments.

FIG. 13 illustrates a screenshot of exemplary user interface controls for a two-dimensional implementation of a popcorn plugin, in accordance with various embodiments.

FIG. 14A-14C are a flow chart illustrating exemplary steps performed by a trajectory generator for a popcorn plugin, in accordance with various embodiments.

FIG. 15 illustrates a screenshot of exemplary user interface controls for a two-dimensional implementation of a pulse plugin, in accordance with various embodiments.

FIG. 16 is a flow chart illustrating exemplary steps that may be utilized for providing a gain modulation function of one or more plugins, such as a pulse plugin, in accordance with various embodiments.

FIG. 17 illustrates a screenshot of exemplary user interface controls for a two-dimensional implementation of a bumblebee plugin, in accordance with various embodiments.

FIG. 18A-18B are a flow chart illustrating exemplary steps performed by a trajectory generator for a bumblebee plugin, in accordance with various embodiments.

### DETAILED DESCRIPTION

Certain embodiments may be found in a method and system for providing spatial sound production tools operable to generate dynamically moving sounds. Various embodiments provide a technical effect of expanding a palette of spatial sound options available to sound artists. Aspects of the present disclosure have a technical effect of providing controls to create dynamic sounds with specific characteristics in a two-dimensional (2D) and/or three-dimensional (3D) space. Certain embodiments have the technical effect of providing spatial sound production tools operable to generate dynamically moving sounds in gaming applications and sound effects in television, movies, or any suitable media. Various embodiments provide a technical effect of providing spatial sound production tools implemented as software plugins in a digital audio workstation (DAW) in a recording studio, a club with a live disc jockey (DJ) sound installation, and/or any suitable environment. In various embodiments, multiple instances of the spatial sound production tools may be implemented simultaneously, such as one tool for each sound object. Furthermore, certain embodiments provide a technical effect of the moving sounds in space synchronized to a beat, lighting effects, and/or video production.

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general-purpose signal processor or a block of random-access memory, hard disk, or the like) or multiple pieces of hardware. Similarly, the programs may be standalone programs, may be incorporated as subroutines in an operating system, may be functions in an installed software package, and the like. It should be understood that the various embodiments are not limited to the arrangements and instrumentality shown in the drawings. It should also be understood that the embodiments may be combined, or that other embodiments may be utilized, and that structural, logical, and electrical changes may be made without departing from the scope of the various embodiments. The following detailed description is, therefore, not to be taken in a limiting sense, and the scope of the present disclosure is defined by the appended claims and their equivalents.

As used herein, an element or step recited in the singular and preceded with the word “a” or “an” should be understood as not excluding plural of said elements or steps, unless such exclusion is explicitly stated. Furthermore, references to “an exemplary embodiment,” “various embodiments,” “certain embodiments,” “a representative embodiment,” and the like are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional elements not having that property.

Furthermore, the term processor or processing unit, as used herein, refers to any type of processing unit that can carry out the required calculations needed for the various embodiments, such as single or multi-core Central Processing Unit (CPU), Accelerated Processing Unit (APU), Graphic Processing Unit (GPU), Digital Signal Processor (DSP), Field Programmable Gate Array (FPGA), System on a Chip (SoC), Application-Specific Integrated Circuit (ASIC), or a combination thereof.

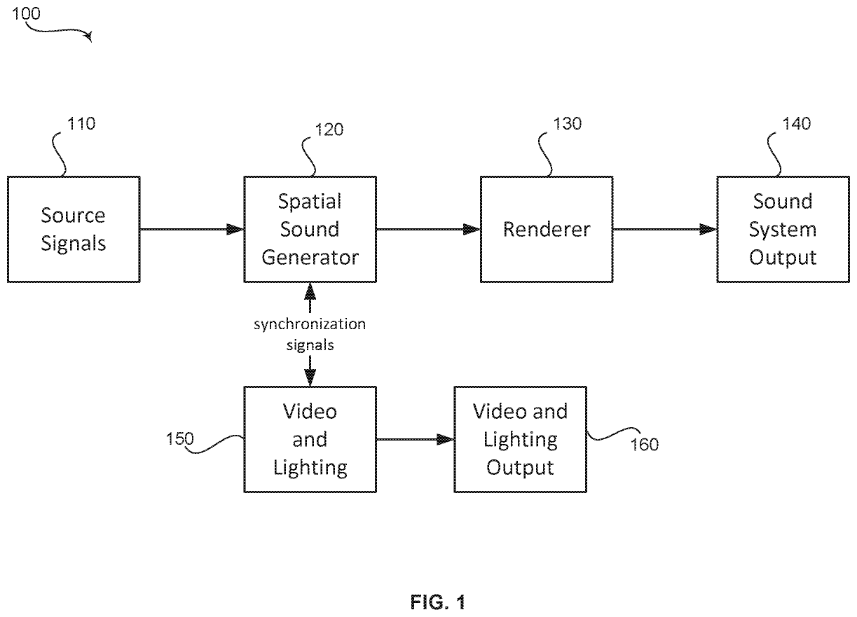

FIG. 1 is a block diagram of an exemplary system 100 that is operable to provide spatial sound production tools operable to generate dynamically moving sounds, in accordance with various embodiments. Referring to FIG. 1, the system 100 comprises audio source input signals 110, spatial sound generator 120, renderer 130, and sound delivery components 140. Synchronization between visual elements, such as video and lighting 150, is provided so the sound 140 and visual movements 160 output by the system 100 can act in a cooperative manner. The source signals 110 may be prerecorded audio tracks, live audio signals, and/or any suitable input audio signals. Live audio signals may be received from a microphone and/or electronic instruments communicatively coupled to the system 100, for example. Prerecorded audio tracks may include, for example, Waveform Audio File Format (.wav) or . mpg files, Musical Instrument Digital Interface (MIDI) tracks, or any suitable audio tracks. Mono input signals, 2-channel stereo input signals, and/or any suitable input signals 110 are supported by the system 100. Examples of input source signals 110 include a single audio signal such as a music instrument recording (e.g., voice track), artificial audio (e.g., drum synthesizer track), and the like.

The spatial sound generator 120 may be implemented by and/or may comprise at least one processor. The spatial sound generator 120 comprises suitable logic, circuits, interfaces, and/or code that is configured to receive the input audio signal 110 and user inputs defining input parameters of audio motion descriptors. The audio motion descriptors may include selectable user settings for implementing the spatial sound production tools operable to generate dynamically moving sounds. For example, the audio motion descriptors can include an output level (i.e., volume), an audio starting position, an audio ending position, an audio starting angle, an audio ending angle, an audio spatial width, an audio movement direction, settings to toggle the movement direction of the audio, settings to pause a position of the audio, audio movement speed settings (e.g., angular velocity, beat velocity, beats per minute, width velocity, repetition velocity, and the like), and/or any suitable selectable audio motion descriptors. The spatial sound generator 120 may be configured to process the input parameters of the audio motion descriptors to generate a trajectory signal in time synchronization with the input audio signal 110. The trajectory signal defines position information (e.g., spherical polar coordinates) over time and is provided to the renderer 130. In a representative embodiment, the trajectory signal may be provided to a graphical user interface to present a visual mapping of the audio signals in space during playback.

In various embodiments, the spatial sound generator 120 may be configured to extract attributes from the input audio signal 110, such as an audio onset (e.g., when music or voice begins), audio envelope, audio pitch, audio beat, and/or any suitable attributes of the input audio signal 110. The spatial sound generator 120 may be configured to generate the trajectory signal based in part on the extracted attributes, such as synchronizing movement of the audio or the rate of movement of the audio with the audio beats, positioning the audio in space based in part on an audio pitch, and/or any suitable attribute-based effect. In certain embodiments, the spatial sound generator 120 may be configured to provide synchronization signals to cooperating external systems, such as video systems, lighting systems, and/or any suitable cooperating systems based on the extracted attributes. For example, the spatial sound generator 120 may output the extracted audio beat to video and/or lighting systems 150 for outputting video and/or lighting visual displays 160 synchronized to the beats of the audio signal 110.

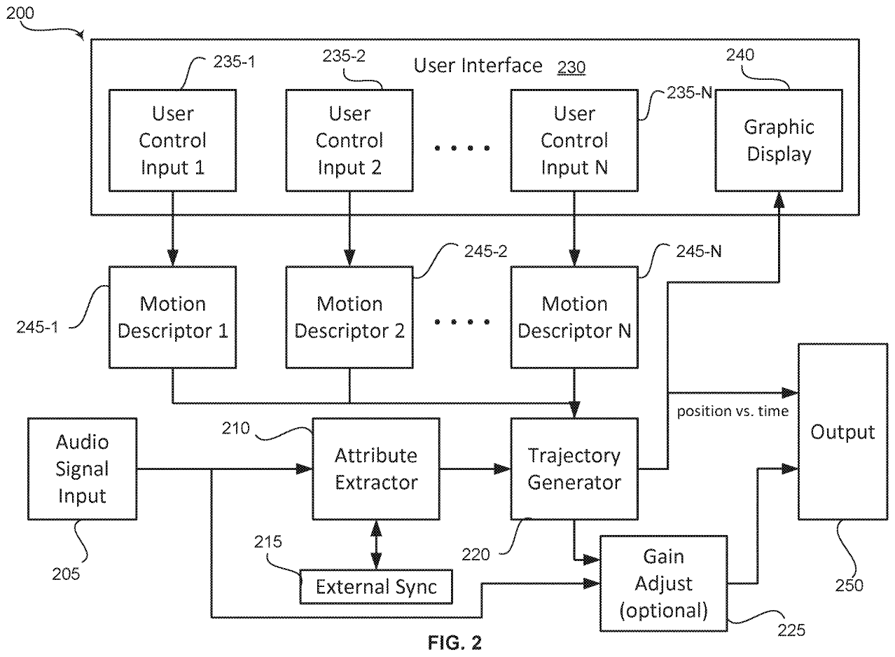

FIG. 2 is a block diagram 200 of an exemplary spatial sound generator 120 of FIG. 1, in accordance with various embodiments. Referring to FIG. 2, the spatial sound generator 120, 200 may include a user interface 230 comprising user controls 235-1, 235-2, 235-N, such as sliders, levers, knobs, switches, and the like. These user controls 235-1, 235-2, 235-N may be operable to set the values for input parameters (motion descriptors) such as starting position, ending position, velocity, spatial width, direction toggle, and the like. The user controls 235-1, 235-2, 235-N may be integrated into a visual graphic display 240 of the sound motion. The user controls 235-1, 235-2, 235-N are dynamic and can be adjusted in real-time. Specific examples are described below in more detail.

The attribute extractor 210 may comprise suitable logic, circuitry, interfaces, and/or code operable to analyzes the audio input signal 205, such as the audio input signal 110 of FIG. 1, for specific values such as onset and envelope detection, pitch detection, beat detection, and the like. These values may be provided to a trajectory generator 220 for producing a sound trajectory depending on the desired sound movement. For example, onset and beat detection could trigger a starting and stopping of particular movements. Pitch detection could match a sound pitch to a particular location in space. Such a mapping could produce a virtual “pipe organ.” The trajectory generator 220 may comprise suitable logic, circuitry, interfaces, and/or code operable to take the desired user settings and audio input signal parameters and computes a sound path trajectory signal to accompany the input signal 205. The main output of the trajectory generator is in the form of position information in spherical polar coordinates (distance r, polar angle θ, azimuth angle φ) versus time. This trajectory signal is in time synchronization with the input signal 205. The trajectory signal is also sent to the user interface 230 so the sound motion can be visualized at the graphic display 240. The output signals 250 are sent to the renderer 130 of FIG. 1 to produce the desired sound output 140 depending on the listening environment. An auxiliary output of the trajectory generator controls an optional gain adjustment 225 to the input signal 205 prior to rendering 130, 250. If needed, the gain adjustment 225 can be used to adjust the overall level and/or to provide faster onset and offset gain adjustments to smooth out abrupt sound path changes.

Referring again to FIG. 1, the output 250 of the spatial sound generator 120, 200 is sent to renderer 130 to be rendered for a specific playback environment. The renderer 130 may be implemented by and/or may comprise at least one processor. In various embodiments, the spatial sound generator 120 and the renderer 130 may be implemented by and/or may comprise the same at least one processor or different processors. The renderer 130 may comprise suitable logic, circuitry, interfaces, and/or code operable to convert the audio input signal 110, 205 and its position signal into the appropriate set of audio signals to be delivered to the sound system output 140 to create the desired effect. Many types of renderers 130 are available depending on the desired playback environment. Some examples include multi-channel amplitude panning as described in WEST, J. R., “Five-Channel Panning Laws: An Analytical and Experimental Comparison,” Master's Thesis, Music Engineering, University of Miami, Spring 1998, 150 pages; Vector-basis amplitude panning (VBAP), which is described in PULKKI, Ville, “Virtual Sound Source Positioning Using Vector Base Amplitude Panning,” J. Audio Eng. Soc., Vol. 45, No. 6, pp. 456-466 (1997 June); Ambisonics as described in GERZON, Michael A., “Periphony: With-Height Sound Reproduction,” J. Audio Eng. Soc., 1973, 21(1), pp. 2-10; Wave Field Synthesis (WFS) as described in BERKHOUT, A. J., “A Holographic Approach to Acoustic Control,” J. Audo Eng. Soc., Vol. 36, No. 12, December 1988, pp. 977-995; Binaural synthesis as described in NIXON, Thomas, et al., “Developing a Binaural Renderer for Audio Definition Model Content,” Audio Engineering Society, 152nd Convention Preprint 668, May 2022, pp. 1-5; Dolby Atmos as described in Digital Cinema Report, Jun. 25, 2019, “DTS: X: The immersive audio standard, explained,” CNET, Sept. 26, 2016, https://www.cnet.com/tech/home-entertainment/dts-x-the-dolby-atmos-alternative-explained, 3 pages; and MPEG-H as described in BLEIDT, R. L., et al., “Development of the MPEG-H TV Audio System for ATSC 3.0,” IEEE Transactions on Broadcasting, Vol. 63, No. 1, March 2017, pp. 202-236, each of the above-mentioned references hereby incorporated herein by reference in its entirety. The desired rendering 130 is selectable by a user and may be based at least in part on the available sound playback systems 140.

The output of the renderer 130 is sent to a sound system 140 for audio playback. The renderer 130 and the sound system 140 are correlated. For example, for binaural rendering 130, the sound system 140 may comprise a headphone amplifier and headphones. For a dance club, the renderer 130 could be amplitude panning of sounds around a ring of loudspeakers and associated amplifiers 140. Certain embodiments support any suitable implementation of a renderer 130 and sound system 140.

Specific implementations of spatial sound manipulations can be devised based on the framework shown in FIGS. 1 and 2. For example, audio signals 110 could reside in a digital audio workstation (DAW) and rendering 130 could be N-channel amplitude panning intended for a circular array of eight speakers 140 in a playback environment. For this specific implementation, the spatial sound generator 120 and rendering 130 functions depicted in FIGS. 1 and 2 could be implemented as software plugins within the DAW software (e.g., PROTOOLS, ABLETON, REAPER, and the like.). Different examples of spatial sound manipulations are described below as “plugins” in recognition of this specific embodiment. The below exemplary spatial sound manipulation effects may additionally and/or alternatively be implemented via the systems of FIGS. 1 and 2.

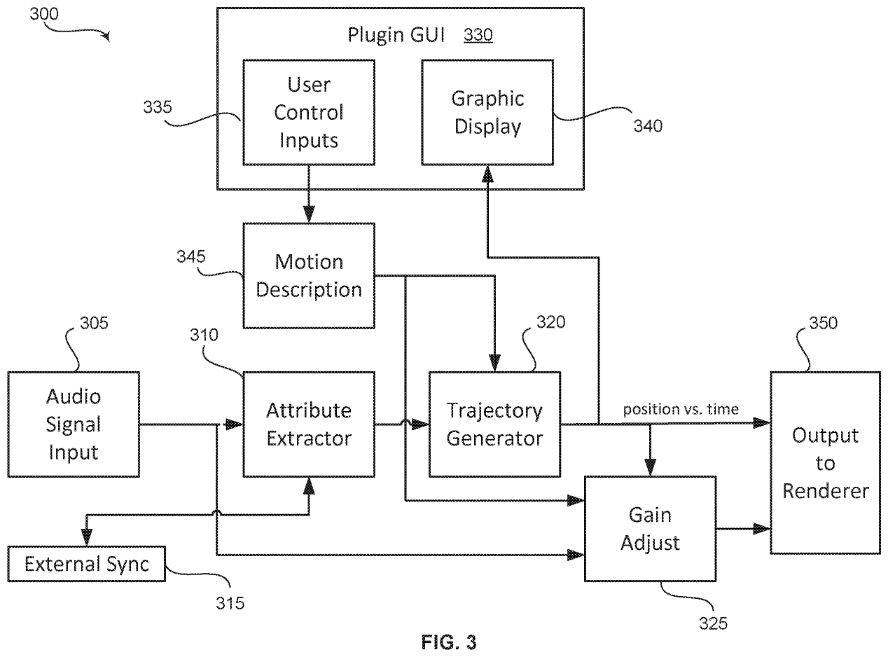

FIG. 3 is a block diagram 300 of an exemplary spatial sound generator 120 of FIG. 1 implemented as a digital audio workstation (DAW) plugin, in accordance with various embodiments. Referring to FIG. 3, the motion description function 345 converts the graphical user interface (GUI) 330 controls 335 to specific values to be used in the trajectory generator function 320. The GUI 330 directly controls the overall gain via the Gain Adjust function 325. Other inputs to the trajectory generator 320 are attributes extracted by the attribute extractor 310. Attribute extractor 310 may be configured to trigger motion when an active audio input is present and otherwise freeze motion. Attribute extractor 310 may be configured to synchronize different sounds when mixing them together. In an exemplary embodiment, attribute extractor 310 may be configured to provide the option of synchronizing the beat of a sound with its motion thus offering a new way for music artists to create compelling musical compositions. In certain embodiments, attribute extractor 310 may be configured to extract beats to switch the angular velocity of spatial motion from units of degrees per second to beats per repetition. Note that the signal and beat detection signals provided by attribute extractor 310 may be shared in a bidirectional way with the lighting and visual systems 150, 160 thereby offering the possibility of synchronized, multisensory experiences.

### Position Plugin

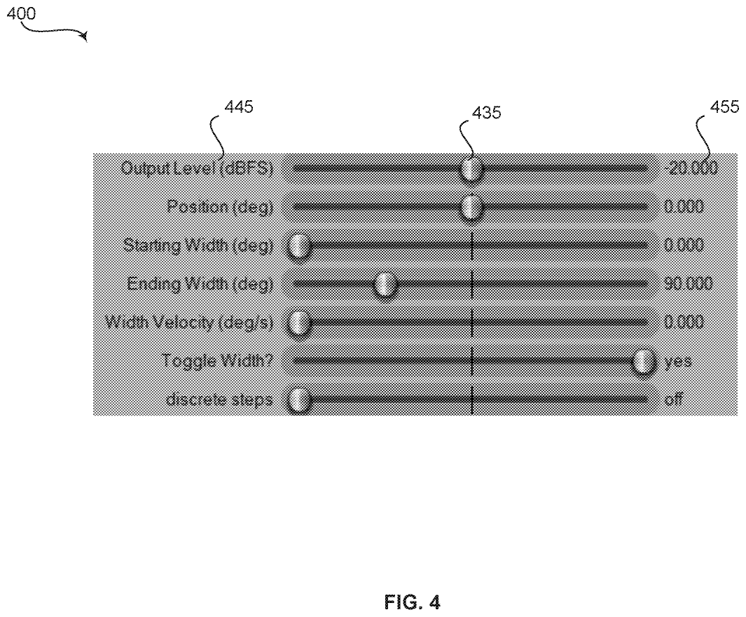

A first example of dynamic sound manipulation is a “Position” plugin or effect, which is operable to move a sound in expanding/contracting pattern from a selected position in the listening space. The controls 235-1, 235-2, 235-N, 335 for this user interface 230, 330 may be configured to set input parameters of motion descriptors 245-1, 245-2, 245-N, 345, such as the output level (e.g., volume), a position of the sound, a starting width of the sound, an ending width of the sound, a velocity at which the width of the sound changes, whether to toggle the width (i.e., expand and contract) or restart at the starting width after reaching the ending width, and the like. An example user interface 400 of controls 435 for setting values 455 of motion descriptors 445 in a simplified two-dimensional implementation is shown in FIG. 4. FIG. 4 illustrates a screenshot of exemplary user interface controls for a two-dimensional implementation of a position plugin, in accordance with various embodiments. Referring to FIG. 4, sliders 435, levers, or any suitable user interface element 435, controls values 455 of motion descriptors 445, such as the relative output level in decibels (dB), the position in degrees, the starting and ending width in degrees, and the width velocity (degrees/second). The spatial width is centered around the specified position. The width velocity controls the rate of spatial width modulation. Toggle-like controls are used to specify whether to toggle the spatial width back and forth or expand then reset to the starting width, and whether the motion is continuous or jumps to and from each speaker.

The trajectory generator 220, 320 in the particular instance of a position plugin or effect is configured to position the sound in response to a manual setting of the position control 435 via the user interface 230, 330, 400. The spatial width variable has a priori knowledge of the speaker locations of the sound system output 140. The trajectory generator 220, 320 is configured to convert a single position into multiple positions depending on the desired width in degrees and the spacing of loudspeakers of the sound system output 140. For example, assuming a circular ring of speakers spaced at angles of 45 degrees, an additional source position could be increased as the width increased above integer multiples of 45 degrees until the width encompassed the full circle. Although the trajectory generator 220, 320 can assume equal spacing between speakers, it is not mandatory to create a compelling effect. Other speaker location geometries can also be supported. The gains for each source can be adjusted by gain adjust 225 to keep the overall sound level relatively equal. The gain adjust 225 may be configured to split the input signal 110, 205, 305 into an array to match the width positions. The output of the trajectory generator 225, 325 and gain adjust 225 becomes an array of signals as the width input creates more source positions. The output of the trajectory generator 225, 325 is also used to provide an animation of the sound motion at a graphic display 240, 340 of the user interface 230, 330.

The spatial width operates on the linear equation:

spatial width(t)=last width+width direction*width velocity*t; (1)

In Equation 1, t is time, last width is the last width value between buffer computations, width direction is a value of +/−1 to specify whether the spatial width is expanding or contracting, and width velocity is velocity in degrees per second. User input controls 235-1, 235-2, 235-N, 335, 435 put specific limitations on Equation 1. For example, if the width toggling is active, the width direction value flips polarity when the width reaches the desired endpoint. The discrete step function has a priori knowledge of the speaker locations of the sound system output 140. If active, the position and width output values are rounded to the nearest speaker location.

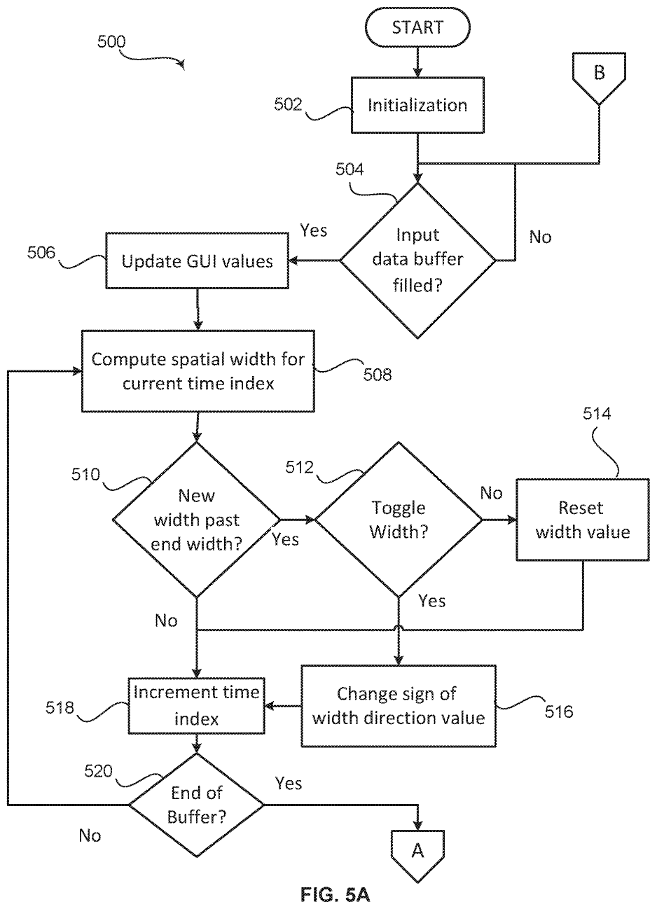

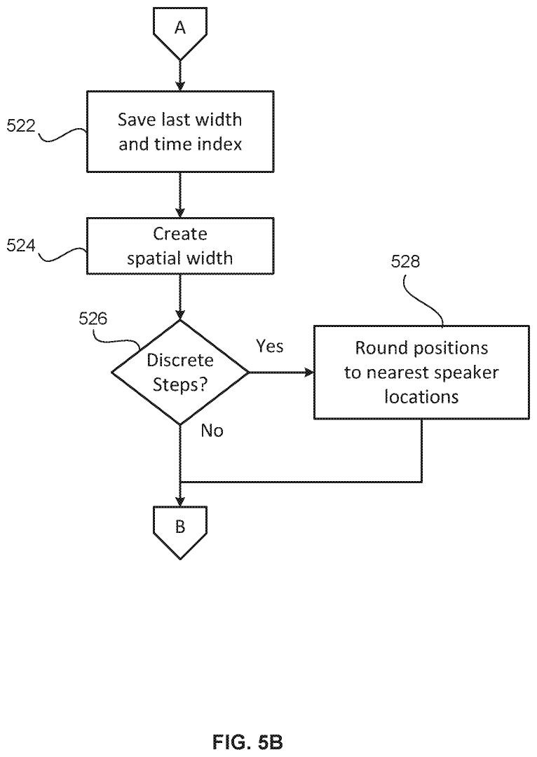

The software operation of the position plugin or effect implemented by the trajectory generator 220, 320 is summarized in the flowchart 500 in FIG. 5A-5B. FIGS. 5A-5B are a flow chart 500 illustrating exemplary steps 502-528 performed by a trajectory generator 220, 320 for a position plugin, in accordance with various embodiments. Referring to FIG. 5A, at step 502, the trajectory generator 220, 320 is initialized. For example, the motion descriptors 245, 345, 445 may be defined and set to default values 455, the speaker layout and renderer information may be defined, applicable attributes (e.g., beats) extracted from the input audio signals 110, 205, 305 may be defined, a buffer size may be set, and/or any suitable initializations. At step 504, a buffer of the trajectory generator 220, 320 may be filled with samples of the audio input signal 110, 205, 305. For example, the steps 504-528 performed by the trajectory generator 220, 320 are implemented as a real-time loop to accept a buffer of audio input values and to output a buffer of audio and a buffer of spatial width values to the renderer 130 for each buffer of audio input values. Once another input buffer is filled at step 504, the user input control values 455 are updated at step 506. At step 508, the trajectory generator 220, 320 computes the next spatial width value using Equation 1 above. At step 510, if the new width value is less than the desired ending width, then the time index is incremented at step 518 and the operation loops back to computing Equation 1, until the end of the audio buffer is reached at step 520. If the new width exceeds the desired ending width at step 510, then the trajectory generator 220, 320 determines whether the toggle width is set at step 512. If toggling the width is set at step 512, then the width direction value changes sign at step 516. If toggling the width is not set at step 512, then the spatial width value is reset at step 514 to the desired starting width. This loop 508-520 repeats until the end of the audio buffer is reached. Once the new spatial width buffer has been filled at step 520, the last spatial width value and time index are saved at step 522 for when a new buffer is ready to be computed.

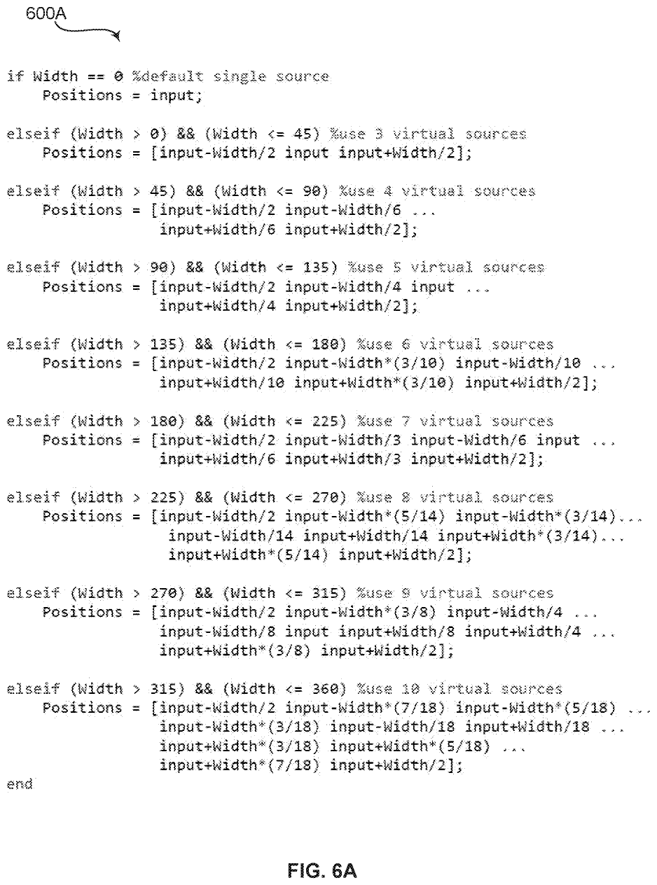

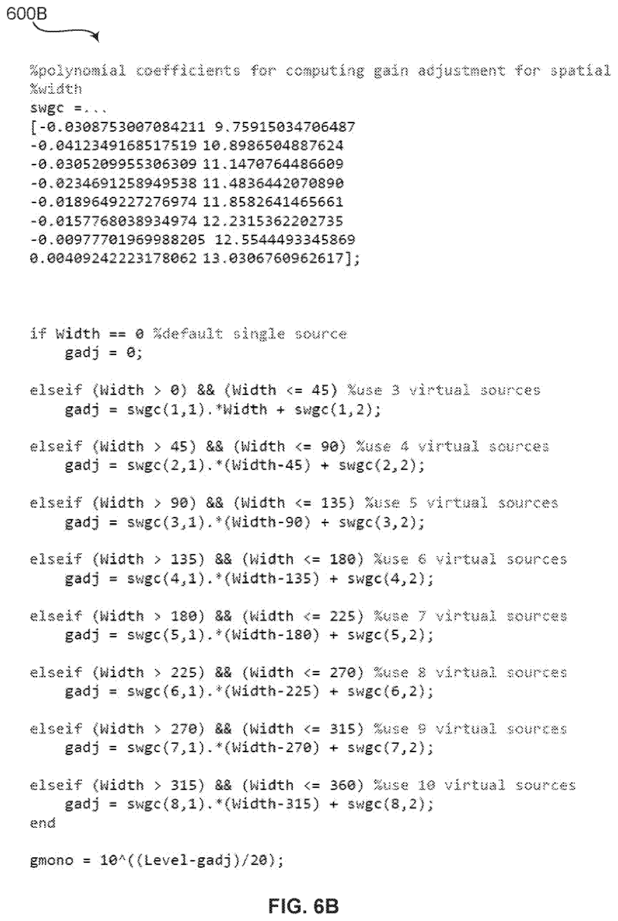

At step 524, the desired spatial width is created, which corresponds with the trajectory signal in time synchronization with the audio signal. The desired spatial width (i.e., trajectory signal) defines position information in spherical polar coordinates over time. For this position effect embodiment, the spatial width is changed by varying the number of virtual source positions depending on the desired width. An alternative method of varying spatial width is to use decorrelation between speaker signals as described in KENDALL, G. S., “The Decorrelation of Audio Signals and Its Impact on Spatial Imagery,” Computer Music Journal, Vol. 19, No. 4, pp. 71-87, (1995), which is incorporated by reference herein in its entirety. The exemplary process is described in MATLAB software code shown in FIG. 6A-6B. FIG. 6A-6B illustrates exemplary software code 600A, 600B for implementing a spatial width function, which corresponds with the spherical polar coordinates over time as output by the trajectory generator 220, 320 of the spatial sound generator 120, 200, 300, in accordance with various embodiments. If the width is set to zero, the output is the single buffer input. As shown in FIG. 6A, as the width increases, the number of sources is increased at multiples of forty-five degrees. The output then becomes a matrix of buffers, one column per source. The additional positions are equally spread across the desired width. As the number of sources increases, the gain is adjusted by gain adjust 225 to keep the overall gain relatively constant in the playback environment. The scheme for adjusting the gain is described in FIG. 6B. The spatial width gain constants (swgc) were derived to achieve a net overall sound output level variation of under +/−1 dB in the center position of a circular array of eight equally-spaced speakers. The overall gain value (gmono) is applied to all of the source positions. Referring again to FIG. 5B, if the trajectory generator 220, 320 determines that discrete steps was selected by the user via user interface 230, 330, 400 at step 526, the trajectory generator 220, 320 rounds the position values to the nearest speaker locations at step 528. The process 500 then returns to step 504 until the sampling of audio signal 110, 205, 305 is finished.

### Twirl Plugin

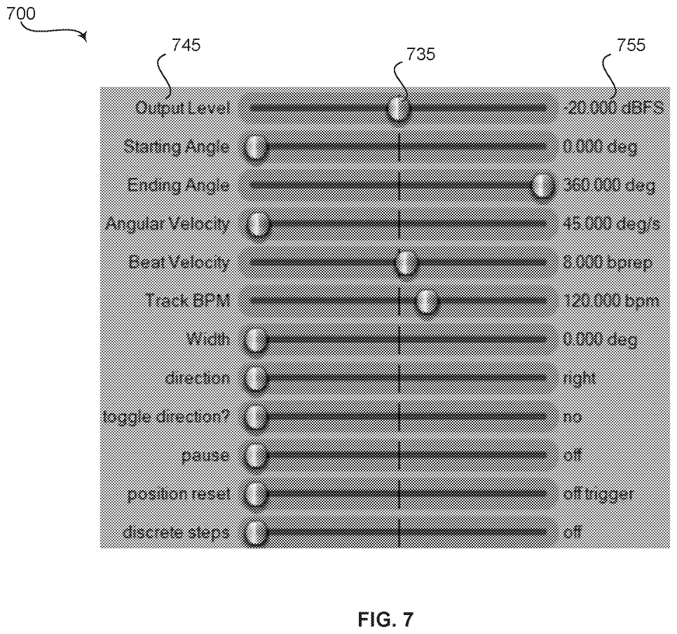

Another example of a dynamic sound manipulation is a “Twirl” plugin or effect. In this embodiment, the sound is manipulated to move in a circular or semi-circular pattern in the listening space. The controls 235-1, 235-2, 235-N, 335 for this user interface 230, 330 may be configured to set input parameters of motion descriptors 245-1, 245-2, 245-N, 345, such as the starting and ending position of the sound, a velocity of the sound, a directional path of the sound, and the like. An example user interface 700 of controls 735 for setting values 755 of motion descriptors 745 in a simplified two-dimensional implementation is shown in FIG. 7. FIG. 7 illustrates a screenshot of exemplary user interface controls for a two-dimensional implementation of a twirl plugin, in accordance with various embodiments. Referring to FIG. 7, sliders 735, levers, or any suitable user interface element 735, controls the relative output level in decibels (dB), the starting and ending angles in degrees, the angular velocity (degrees/second), beat velocity (beats per repetition), track BPM (beats per minute), and sound width in degrees. If the angular velocity is set to a value less than zero, then the angular velocity may be set by the trajectory generator 220, 320 using the desired beat velocity and track BPM. Toggle-like controls are used to specify direction (clockwise or counter-clockwise in this simplified instance), whether to toggle the direction back and forth or one direction only, a motion pause, a position reset to the starting angle, and whether the motion is continuous or jumps to and from each speaker.

The trajectory generator 220, 320 in the particular instance of a twirl plugin may be configured to apply the linear equation:

position(t)=last position+direction*angular velocity*t; (2)

In Equation 2, t is time, last position is the last position value between buffer computations, direction is a value of +/−1 to specify which direction on the path to travel, and angular velocity is velocity in degrees per second. User input controls 235-1, 235-2, 235-N, 335, 735 put specific limitations on Equation 1. For example, if the direction toggling is active, the direction value flips polarity when the position reaches the desired endpoints. If the pause is on, the position output value is held at the value when pause was activated. Also, if the starting and ending angles are identical (modulo 360 degrees), the sound moves in a constant circular motion. The discrete step function has a priori knowledge of the particular speaker locations. If active, the position output value is rounded to the nearest speaker location.

In various embodiments, the angular velocity setting in Equation 2 may be a constant value that can be manually adjusted. The angular velocity may also be a function of time to produce accelerating and deaccelerating motion using any arbitrary waveform. For example, for the twirl plugin or effect, the velocity may be varied to mimic the motion of the ball on a roulette wheel. This also applies to the position equations in the other plugins described below in Equations 3, 4, and 6. The width setting manually controls the spatial width in a manner similar to that described for the modulating spatial width in the position plugin.

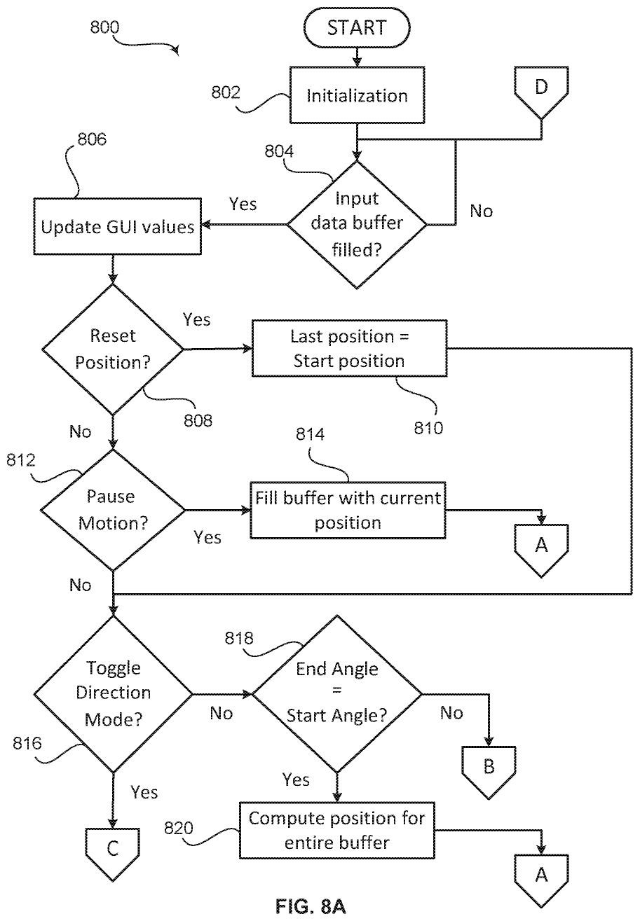

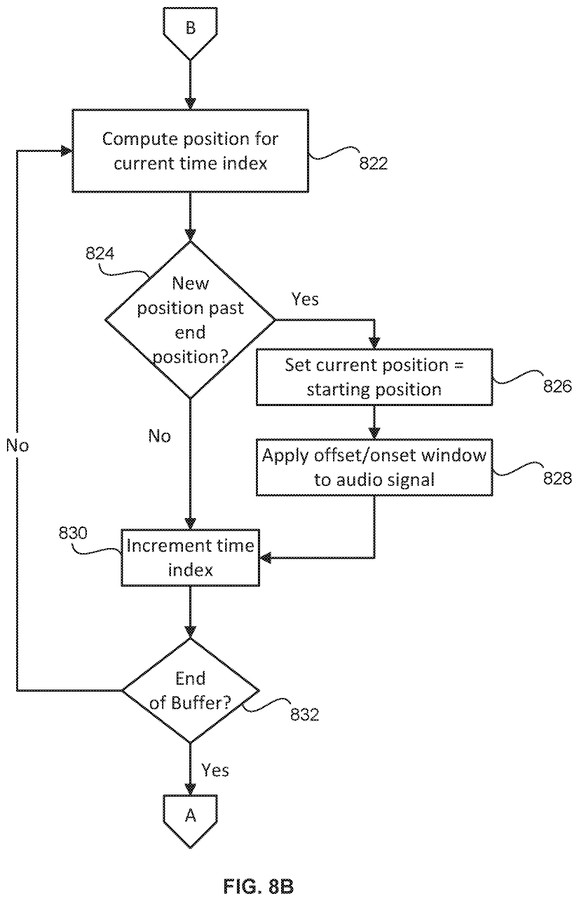

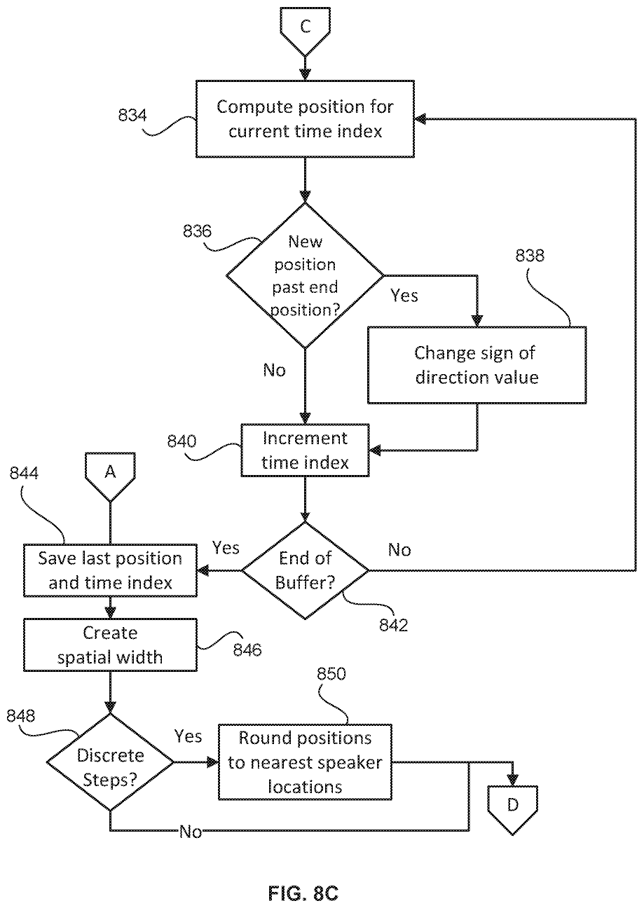

The software operation of the twirl plugin or effect implemented by the trajectory generator 220, 320 is summarized in the flowchart 800 of FIG. 8A-8C. FIG. 8A-8C are a flow chart 800 illustrating exemplary steps 802-850 performed by a trajectory generator 220, 320 for a twirl plugin, in accordance with various embodiments. Referring to FIG. 8A, at step 802, the trajectory generator 220, 320 is initialized. For example, the motion descriptors 745 may be defined and set to default values 755, the speaker layout and renderer information may be defined, applicable attributes (e.g., beats) extracted from the input audio signals 110, 205, 305 may be defined, a buffer size may be set, and/or any suitable initializations. At step 804, a buffer of the trajectory generator 220, 320 may be filled with samples of the audio input signal 110, 205, 305. For example, the steps 804-850 performed by the trajectory generator 220, 320 are implemented as a real-time loop to accept a buffer of audio input values and to output a buffer of audio and directional specification values to the renderer 130 for each buffer of audio input values. Once another input buffer is filled at step 804, the user input control values 755 are updated at step 806. At step 808, if the position reset toggle switch is activated, the last position value in Equation 2 is reset to the starting angle at step 810 and the process proceeds to step 816. If the position reset toggle switch is not activated, the process proceeds to step 812 and the trajectory generator 220, 320 determines whether the user has paused the motion. If the user has paused the motion, then the current position is held by filling the buffer with that value and the process proceeds to step 844. If motion is not paused, the trajectory generator 220, 320 determines whether the user selected the toggle direction motion back and forth or to return the motion to the starting position at step 816. If toggle mode is off, the trajectory generator 220, 320 determines if the user-specified ending and starting positions are equal at step 818, which signifies a special case in which the motion continues in a circular pattern without changing directions. As such, the entire buffer can be computed at step 820 using Equation 2. Otherwise, the process proceeds to step 822 in FIG. 8B to compute the position values one value at a time using Equation 2 while incrementing the time index at step 830 until the buffer is filled at step 832. If the ending position is reached at step 824 prior to filling the buffer at step 832, then the current position is reset back to the starting position at step 826. Given the abrupt position change, the audio signal at the position change is windowed with a brief offset then onset of a few milliseconds to remove any sharp transients created by the change at step 828 using gain adjust 225. Once the buffer is filled at step 832, the process proceeds to step 844 in FIG. 8C.

If direction toggle mode is on at step 816 in FIG. 8A, the process proceeds to step 834 in FIG. 8C, and Equation 2 is applied to compute one position value at a time while incrementing the time index at step 840 until the buffer is filled at step 842. At step 836, if the new position is past the starting or ending positions before the buffer is filled at step 842, the arithmetic sign of the direction value in Equation 2 is changed to reverse direction at step 838. Once the new buffer has been filled at step 842, the last position and time index is saved at step 844 for when a new buffer is ready to be computed.

At step 846, the desired spatial width is created, which corresponds with the trajectory signal in time synchronization with the audio signal. The desired spatial width (i.e., trajectory signal) defines position information in spherical polar coordinates over time. For the twirl effect embodiment, the spatial width is changed by varying the number of virtual source positions depending on the desired width as described above for the position effect embodiment with respect to FIG. 6A-6B. If the trajectory generator 220, 320 determines that discrete steps was selected by the user via user interface 230, 330, 700 at step 848, the trajectory generator 220, 320 rounds the position values to the nearest speaker locations at step 850. The process 800 then returns to step 804 until the sampling of audio signal 110, 205, 305 is finished.

### Surf Plugin

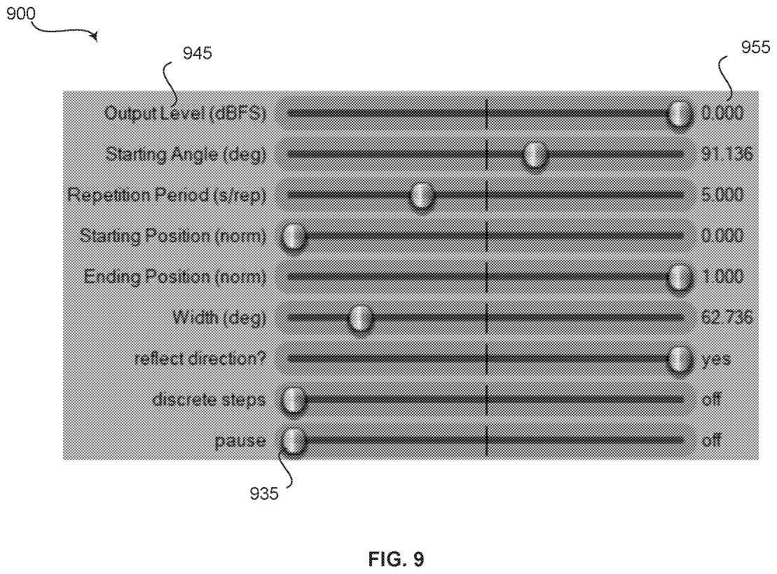

Another specific sound manipulation based on the framework shown in FIGS. 2 and 3 is a “Surf” plugin or effect. In this embodiment, a sound moves across a listening space along a line much like a portion of a wave on the surface of the water. The controls 235-1, 235-2, 235-N, 335 for this user interface 230, 330 may be configured to set input parameters of motion descriptors 245-1, 245-2, 245-N, 345, such as a starting angle, starting and ending position of the sound, a repetition period, reflect toggle, and the like. An example user interface 900 of controls 935 for setting values 955 of motion descriptors 945 in a simplified two-dimensional implementation is shown in FIG. 9. FIG. 9 illustrates a screenshot of exemplary user interface controls for a two-dimensional implementation of a surf plugin, in accordance with various embodiments. Referring to FIG. 9, sliders 935, levers, or any suitable user interface element 935 may control the relative output level in decibels (dB), the starting angle in degrees, the repetition period (seconds/repetition), starting and ending positions normalized to a percentage of the total space distance (0 to 1), and sound width in degrees, for example. Toggle-like controls are used to specify whether to toggle the direction back and forth or only one direction, a motion pause, and whether the motion is continuous or jumps from each speaker. For sake of brevity, the position reset toggle switch used in the twirl plugin described in FIGS. 7 and 8A is omitted from the description of the surf plugin, but could be implemented in an identical manner.

The trajectory generator 220, 320 in the particular instance of a surf plugin may be configured to apply the linear equation:

line position(t)=last position+start offset+direction*starting angle*velocity*t; (3)

In Equation 3, the line position output specifies how far the “wave” has traveled along a line perpendicular to it specified by the starting and ending positions, t is time, last position is the last line position value between buffer computations, start offset is the starting position offset from the endpoint specified as a length calculated as a percentage of the total possible travel along the line, direction is a value of +/−1 to specify which direction to travel, starting angle specifies where the sound begins and its direction of travel in degrees, and velocity is the line velocity in repetitions per second (the inverse of repetition period). User input controls 235, 335, 935 may put specific limitations on Equation 3. For example, if the reflect direction is on, the direction value flips polarity when the line position reaches the desired endpoints. If the pause is on, then the line position output value is held at the value when pause was activated. The starting and ending position values restrict the motion along the line. The discrete step function has a priori knowledge of the particular speaker locations. If active, the position output value is rounded to the nearest speaker location. The trajectory generator 220, 320 for this surf effect embodiment also uses an offset and onset gain windowing of the audio signal for abrupt sound path changes when the wave resets back to the starting position after reaching the end position. The output of the trajectory generator 220, 320 is also used to provide an animation of the sound motion at the graphic display 240, 340 in the user interface 230, 330.

The width variable is like that used for the twirl plugin described above using a priori knowledge of the speaker locations. The width variable specifies how many sources are created along the line of the wave. For the example case using a circular ring of speakers spaced at angles of 45 degrees, each source becomes projected onto the circle and mimics the wave travel via amplitude panning along the circle of two virtual sources moving in opposite directions.

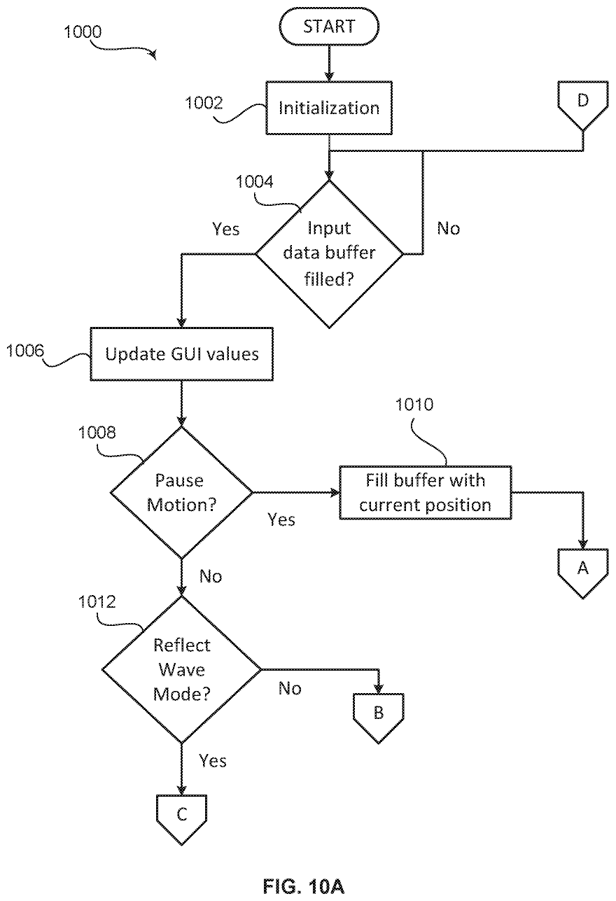

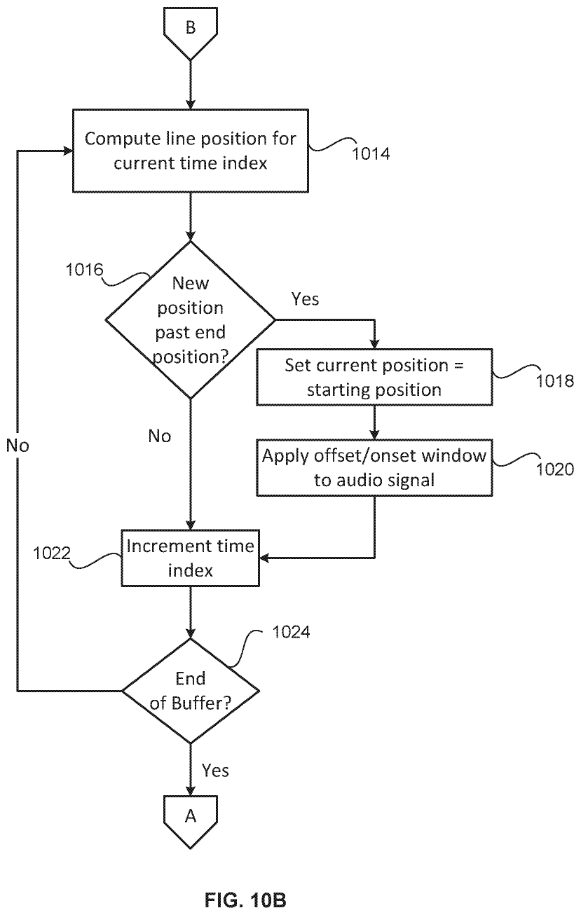

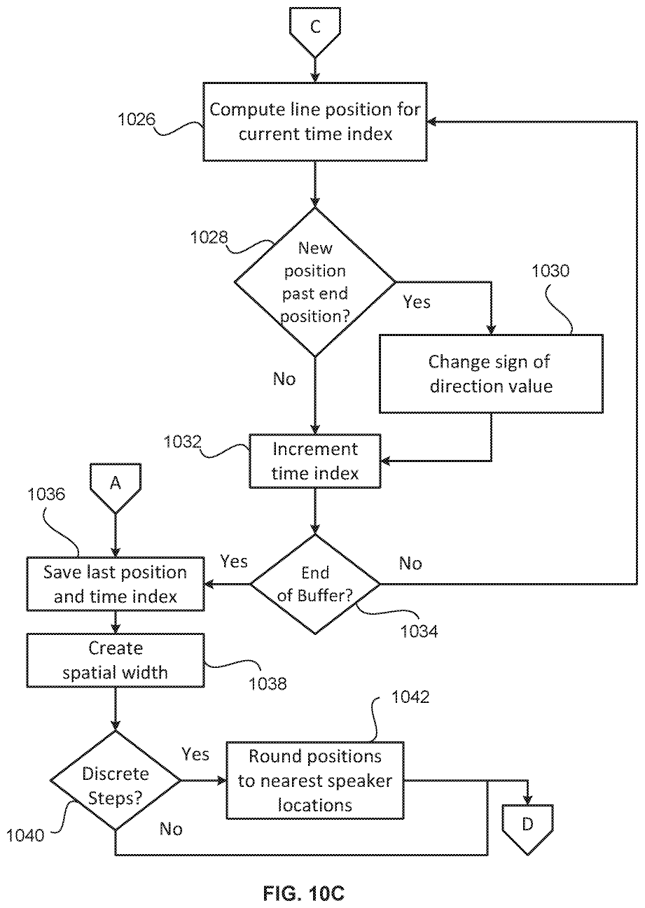

The software operation of the surf plugin or effect provided by the trajectory generator 220, 320 is summarized in the flowchart 1000 in FIG. 10A-10C. FIG. 10A-10C are a flow chart 1000 illustrating exemplary steps 1002-1042 performed by a trajectory generator 220, 320 for a surf plugin, in accordance with various embodiments. Referring to FIG. 10A, at step 1002, the trajectory generator 220, 320 is initialized. For example, the motion descriptors 945 may be defined and set to default values 955, the speaker layout and renderer information may be defined, applicable attributes (e.g., beats) extracted from the input audio signals 110, 205, 305 may be defined, a buffer size may be set, and/or any suitable initializations. At step 1004, a buffer of the trajectory generator 220, 320 may be filled with samples of the audio input signal 110, 205, 305. For example, the steps 1004-1042 performed by the trajectory generator 220, 320 are implemented as a real-time loop to accept a buffer of audio input values and to output a buffer of audio and directional specification values to the renderer 130 for each buffer of audio input values. Once another input buffer is filled at step 1004, the user input control values 955 are updated at step 1006. At step 1008, if the user has paused the motion, then the current position is held by filling the buffer with that value at step 1010 and the process 1000 proceeds to step 1036. If motion is not paused, the trajectory generator 220, 320 determines whether the user selected the reflect wave mode at step 1012. If wave reflection mode is off, the trajectory generator 220, 320 computes the line position values one value at a time using Equation 3 at step 1014 while incrementing the time index at step 1022 until the buffer is filled at step 1024. If the ending position is reached at step 1016 prior to filling the buffer at step 1024, then the current position is reset back to the starting position plus the position offset at step 1018. Given the abrupt position change, the audio signal at the position change is windowed with a brief offset then onset of a few milliseconds to remove any sharp transients created by the change at step 1020. Once the buffer is filled at step 1024, the process proceeds to step 1036 in FIG. 10C.

If wave reflection mode is on at step 1012 in FIG. 10A, the process proceeds to step 1026 in FIG. 10C, and Equation 3 is applied to compute one position value at a time while incrementing the time index at step 1032 until the buffer is filled at step 1034. At step 1028, if the new position is past the starting or ending positions, including the offsets, before the buffer is filled at step 1034, the arithmetic sign of the direction value in Equation 3 is changed to reverse direction at step 1030. Once the new buffer has been filled at step 1034, the last position and time index is saved at step 1036 for when a new buffer is ready to be computed.

At step 1038, the desired spatial width is created, which corresponds with the trajectory signal in time synchronization with the audio signal. The desired spatial width (i.e., trajectory signal) defines position information in spherical polar coordinates over time. For the surf effect embodiment, the spatial width is changed by varying the number of virtual source positions depending on the desired width as described above for the position effect embodiment with respect to FIG. 6A-6B. If the trajectory generator 220, 320 determines that discrete steps was selected by the user via user interface 230, 300, 400 at step 1040, the trajectory generator 220, 320 rounds the position values to the nearest speaker locations at step 1042. The process 1000 then returns to step 1004 until the sampling of audio signal 110, 205, 305 is finished.

### Ping Pong Plugin

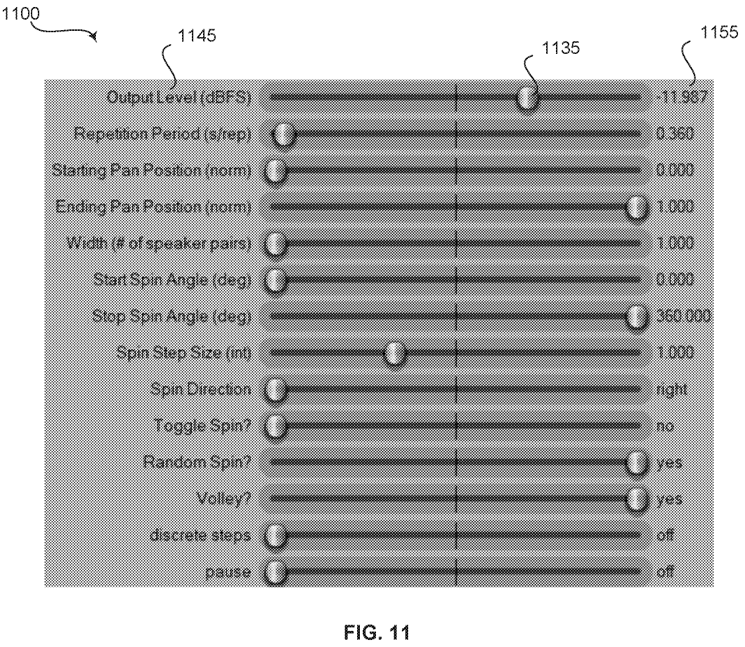

Another specific sound manipulation based on the framework shown in FIGS. 2 and 3 is a “Ping Pong” plugin or effect. In this embodiment, a sound moves back and forth along a line between two endpoints mimicking the volleying of a ping pong ball. The controls 235-1, 235-2, 235-N, 335 for this user interface 230, 330 may be configured to set input parameters of motion descriptors 245-1, 245-2, 245-N, 345, such as starting and ending positions, repetition period, width, and the like. An example user interface 1100 of controls 1135 for setting values 1155 of motion descriptors 1145 in a simplified two-dimensional implementation is shown in FIG. 11. FIG. 11 illustrates a screenshot of exemplary user interface controls for a two-dimensional implementation of a ping pong plugin, in accordance with various embodiments. Referring to FIG. 11, sliders 1135, levers, or any suitable user interface element 1135 may be configured to control the relative output level in decibels (dB), the repetition period (seconds/repetition), starting and ending positions normalized to a percentage of the total space distance (0 to 1), sound width in number of speaker-pairs, starting and ending spin angles in degrees, and spin step size. For the current embodiment, spin step size is an integer value denoting the number of opposite facing speaker pairs minus one. Toggle-like controls are used to specify spin direction (left/right), random spin (no/yes), volley (no/yes), a motion pause, and whether the motion is continuous or jumps from each speaker. The spin variables describe if and how the ping pong motion rotates (twirls) in time. The beat extracted from the audio signals 110, 205, 305 by the attribute extractor 210, 310 may also be used by the trajectory generator 220, 320 in the ping pong plugin to switch repetition period from units of seconds per repetition to beats per repetition.

The trajectory generator 220, 320 in the particular instance of a ping pong plugin may be configured to apply the linear equation:

position(t)=last position+direction*spin angle(t)*velocity*t; (4)

where

spin angle(t)=last spin angle+spin direction*spin step; (5)

In Equation 4, t is time, last position is the last position value between buffer computations, direction is a value of +/−1 to specify which direction to travel, spin angle specifies line of travel in degrees, and velocity is the velocity in repetitions per second (the inverse of repetition period). In Equation 5, last spin angle is the last spin angle between buffer computations, spin direction is a value of +/−1 specifying a clockwise or counterclockwise rotation, and spin step controls how much to rotate after each repetition of a volley. For an exemplary embodiment of a circular array of eight speakers, spin step takes on a value of 0, 45, 90, or 135 degrees.

The position output specifies how far the “ping pong ball” as virtual sound object has traveled along a line between the specified starting and ending positions. Other user input controls 235-1, 235-2, 235-N, 335, 1135 put specific limitations on Equations 4 and 5. For example, if the volley setting is on, the direction value flips polarity when the position value reaches the desired endpoints. If the pause setting is on, the position value is held at the value when pause was activated. The starting and ending position values restrict the motion along the line. The spin variables control the rotation of the volley direction. The start and stop spin angles limit the amount of volley rotation. The spin step size controls the amount of rotation after each volley. The spin direction value controls whether the spin rotation is clockwise or counterclockwise. The toggle spin variable controls whether rotation goes back and forth between starting and ending spin angles or if rotation resets to the starting angle after reaching the ending angle. Selecting random spin chooses a new random angle for each volley. The discrete step function has a priori knowledge of the particular speaker locations. If active, the spin angle output value is rounded to the nearest speaker location. The trajectory generator 220, 320 for this plugin is configured to apply an offset and onset gain windowing for abrupt sound path changes when the wave resets back to the starting position after reaching the end position. The width value specifies how many simultaneous, parallel sound paths are active. The trajectory generator 220, 320 also uses a priori knowledge of the speaker locations. For the example case using a circular ring of speakers spaced at angles of 45 degrees, each ping pong path is created from a pair of speakers 180 degrees apart.

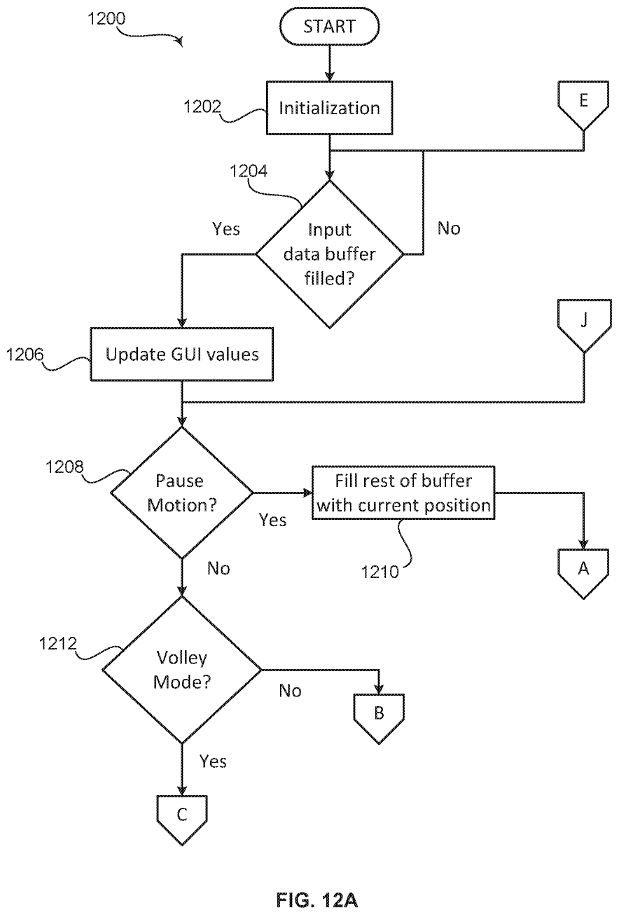

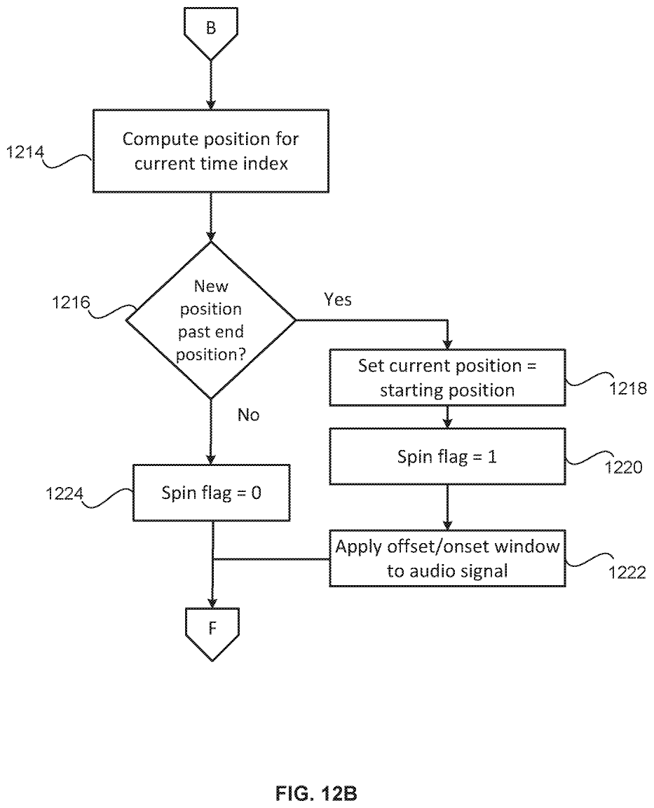

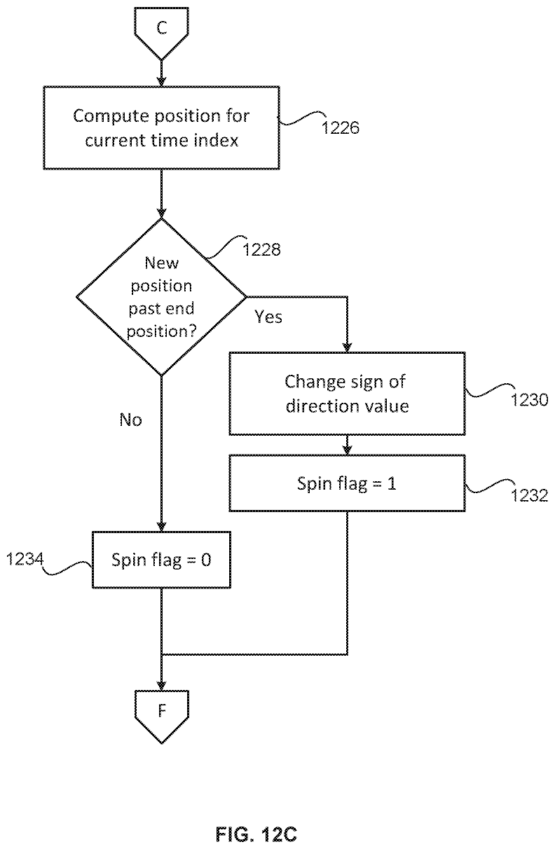

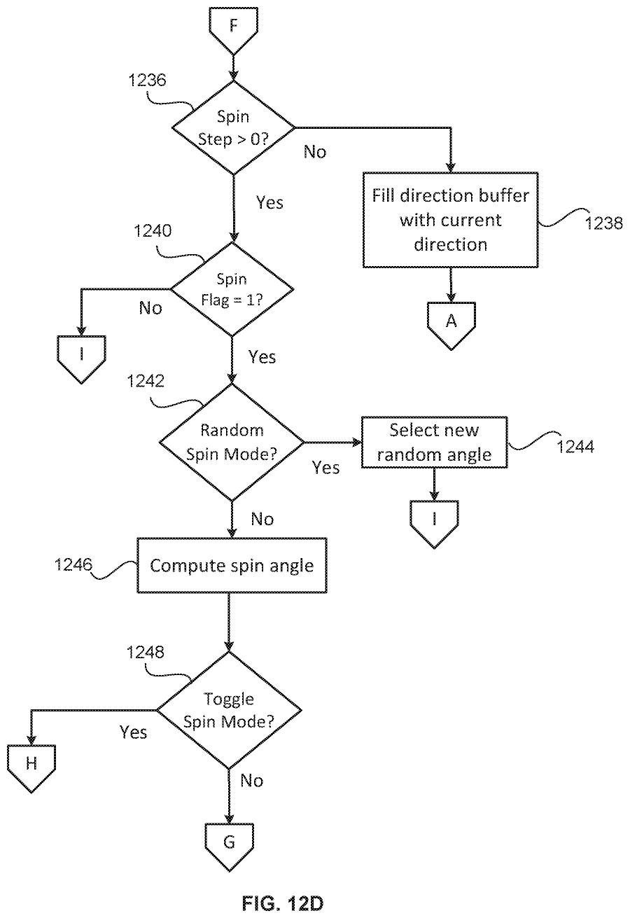

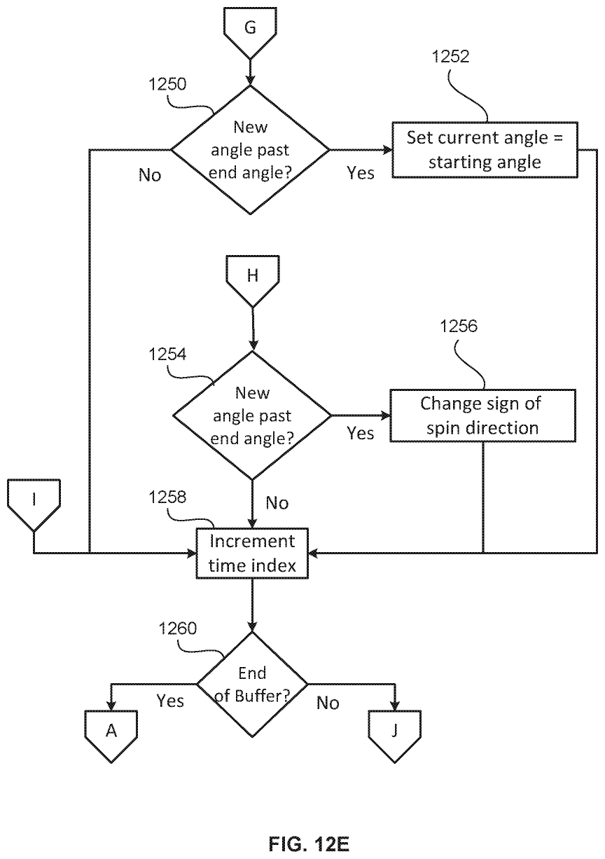

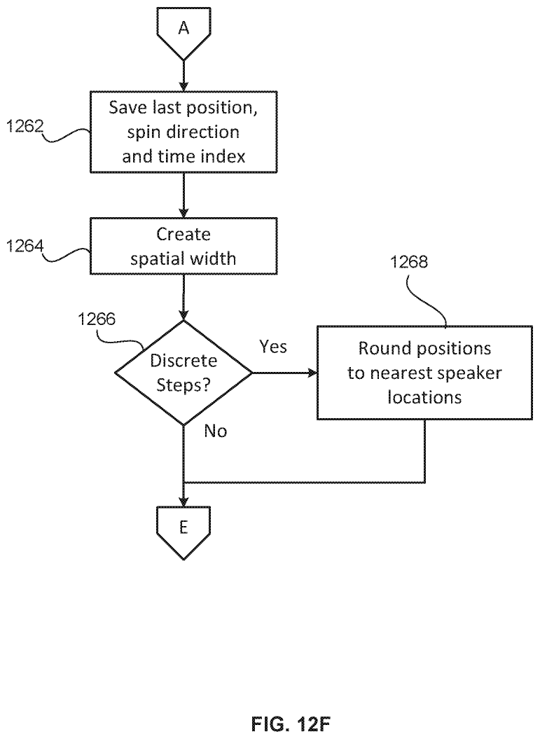

The software operation of the ping pong plugin or effect provided by trajectory generator 220, 320 is summarized in the flowchart in FIG. 12A-12F. FIG. 12A-12F are a flow chart 1200 illustrating exemplary steps 1202-1268 performed by a trajectory generator 220, 320 for a ping pong plugin, in accordance with various embodiments. Referring to FIG. 12A, at step 1202, the trajectory generator 220, 320 is initialized. For example, the motion descriptors 1145 may be defined and set to default values 1155, the speaker layout and renderer information may be defined, applicable attributes (e.g., beats) extracted from the input audio signals 110, 205, 305 may be defined, a buffer size may be set, and/or any suitable initializations. At step 1204, a buffer of the trajectory generator 220, 320 may be filled with samples of the audio input signal 110, 205, 305. For example, the steps 1204-1268 performed by the trajectory generator 220, 320 are implemented as a real-time loop to accept a buffer of audio input values and to output a buffer of audio and directional specification values to the renderer 130 for each buffer of audio input values. Once another input buffer is filled at step 1204, the user input control values 1155 are updated at step 1206. At step 1208, if the user has paused the motion, then the current position is held by filling the buffer with that value at step 1210 and the process 1200 proceeds to step 1262. If motion is not paused, the trajectory generator 220, 320 determines whether the user selected the volley mode at step 1212. If volley mode is off, the trajectory generator 220, 320 computes the position values one value at a time using Equation 4 at step 1214 while maintaining angle direction at step 1224 and incrementing the time index at step 1258 until the buffer is filled at step 1260. If the ending position is reached at step 1216 prior to filling the buffer at step 1260, then the current position is reset back to the starting position plus the position offset at step 1218. A spin flag buffer is used to process changes in angle direction. At step 1220, a flag is set at this time index to denote a change in direction. Given the abrupt position change, the audio signal at the position change is windowed with a brief offset then onset of a few milliseconds to remove any sharp transients created by the change at step 1222 by gain adjust 225.

If volley mode is on at step 1212 in FIG. 12A, the process 1200 proceeds to step 1226 in FIG. 12C and Equation 4 is applied to compute one position value at a time while maintaining angle direction at step 1234 and incrementing the time index at step 1258 until the buffer is filled at step 1260. At step 1228, if the new position is past the starting or ending positions, including the offsets, before the buffer is filled at step 1260, the arithmetic sign of the direction value in Equation 4 is changed to reverse direction at step 1230. At step 1232, a flag is set at this time index to denote a change in direction.

At step 1236, the trajectory generator 220, 320 determines when the spin step is greater than zero. If the spin step is zero, the process 1200 continues to fill the direction buffer with the current direction at step 1238 and then proceeds to step 1262. If the spin step is greater than zero at step 1236, the spin change buffer is iteratively checked for indices in time when the spin flag is set at step 1240. When one is found, a new spin angle is determined at step 1244 or step 1246, depending on whether a random spin mode is on at step 1242. If the random spin mode is selected at step 1242, then a random angle is chosen at step 1244. Creating random angles can take many forms. For example, in the exemplary embodiment of a circular array of eight speakers, a set of random permutations could be used to select a random angle out of the set of eight speaker directions. If random spin mode is off at step 1242, then the next spin direction is calculated using Equation 5 at step 1246. At step 1248, if toggle spin mode is selected, then the process 1200 proceeds to step 1254 where the trajectory generator 220, 320 determines if the new spin angle is greater than the end angle. If the new spin angle is greater than the end angle at step 1254, the sign of the spin direction value in Equation 5 is changed at step 1256, the time index is incremented at step 128 until the buffer is filled at step 1260. If toggle spin mode is off at step 1248, the trajectory generator 220, 320 determines if the new spin angle is greater than the end angle at step 1250. If the new spin angle is greater than the end angle at step 1250, then current spin angle is reset to the starting angle at step 1252, the time index is incremented at step 128 until the buffer is filled at step 1260. Once the buffer is filled at step 1260, process 1200 proceeds to step 1262 where the last position value, the last spin direction, and the time index are saved for when a new buffer is ready to be computed.

At step 1264, the desired spatial width is created, which corresponds with the trajectory signal in time synchronization with the audio signal. The desired spatial width (i.e., trajectory signal) defines position information in spherical polar coordinates over time. For the ping pong effect embodiment, the spatial width is the number of speaker pairs that are actively volleying the sound between each other, which for the exemplary embodiment of a circular array of eight speakers, is one (1), two (2), three (3), or four (4) speaker pairs. The position output is therefore a matrix of one (1) to four (4) columns, one column per active pair. Note that the overall gain is lowered by gain adjust 225 by 0 dB, 6 dB, 9 dB, or 12 dB, respectively, to keep the overall level in the playback environment relatively constant. If the trajectory generator 220, 320 determines that discrete steps was selected by the user via user interface 230, 300, 1100 at step 1266, the trajectory generator 220, 320 rounds the position values to the nearest speaker locations at step 1268. The process 1200 then returns to step 1204 until the sampling of audio signal 110, 205, 305 is finished.

### Popcorn Plugin

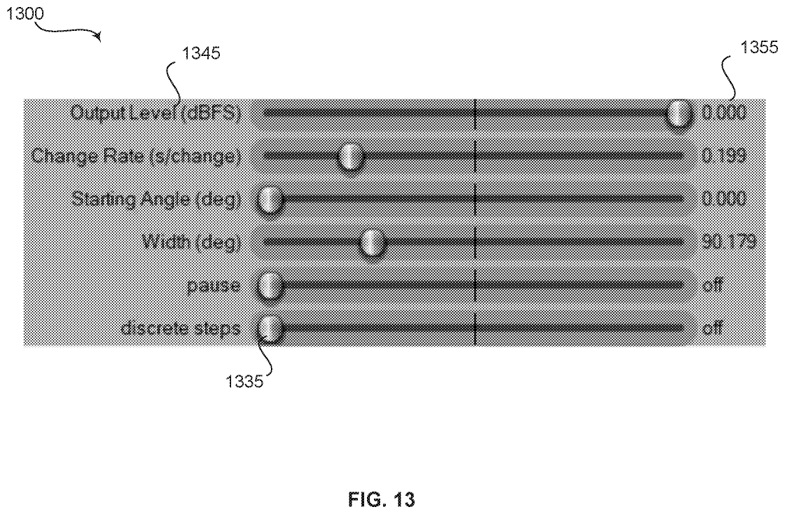

Another specific sound manipulation based on the framework shown in FIGS. 2 and 3 is a “Popcorn” plugin or effect. In this embodiment, a sound randomly appears in different positions, much like the random positions of popcorn kernels when it is popping. The controls 235-1, 235-2, 235-N, 335 for this user interface 230, 330 may be configured to set input parameters of motion descriptors 245-1, 245-2, 245-N, 345, such as starting position, rate of change, width, and the like. An example user interface 1300 of controls 1335 for setting values 1355 of motion descriptors 1345 in a simplified two-dimensional implementation is shown in FIG. 13. FIG. 13 illustrates a screenshot of exemplary user interface controls for a two-dimensional implementation of a popcorn plugin, in accordance with various embodiments. Referring to FIG. 13, sliders 1335, levers, or any suitable user interface element 1335 may control the relative output level in decibels (dB), the change rate (seconds/change), the starting angle (degrees), and the sound width (degrees), for example. Toggle-like controls are provided to allow users to pause motion and control whether the motion is limited to specific speaker locations. The beat extracted from the audio signals 110, 205, 305 by the attribute extractor 210, 310 may also be used by the trajectory generator 220, 320 in the popcorn plugin to change rate from seconds per change to beats per change. Furthermore, an onset detected in the audio signals 110, 205, 305 by the attribute extractor 210, 310 may be used by the trajectory generator 220, 320 in the popcorn plugin to trigger movement changes so that each new sound comes from a different position.

The trajectory generator 220, 320 in the particular instance of a popcorn plugin may be configured to implement a timer and a random position generator to change to a new random sound object location at regular intervals. For the exemplary embodiment of a circular array of eight speakers, the trajectory generator 220, 320 may be configured to randomly select a number may between 0 and 360 degrees. If the discrete steps control is selected, these random number are rounded to the nearest physical speaker location. The gain adjust 225 for this popcorn effect may be configured to apply an offset and onset gain windowing of the audio signal for the abrupt sound position changes. In various embodiments, the output of the trajectory generator 220, 320 may be provided to a graphic display 240, 340 of the user interface 230, 330 for presentation of an animation of the sound motion. In certain embodiments, the width variable is provided in a manner as described above for the position effect using a priori knowledge of the speaker locations.

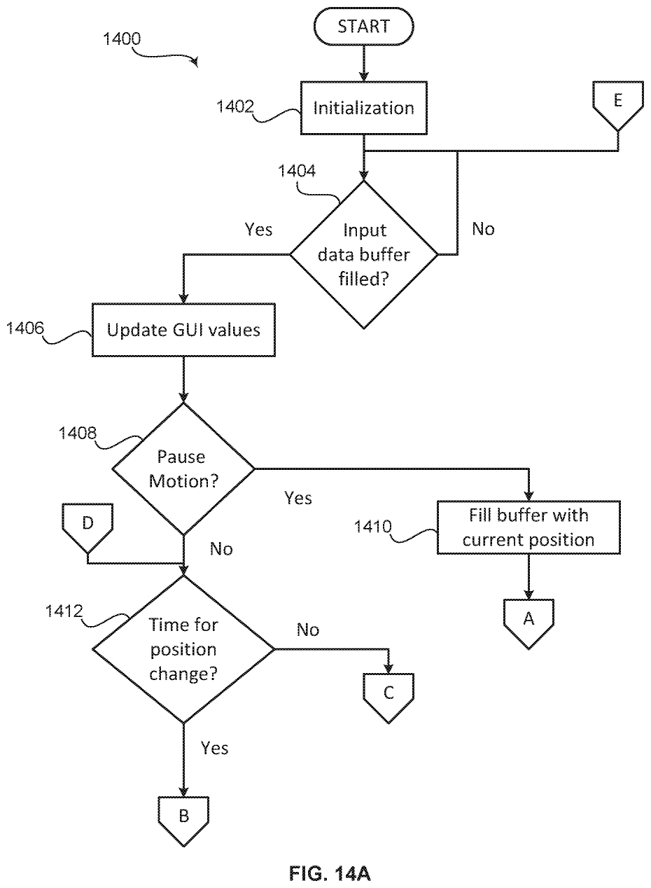

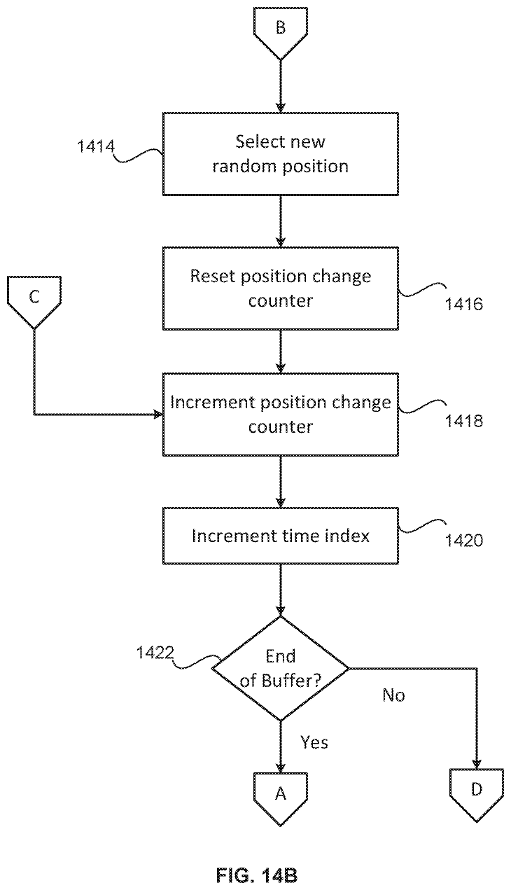

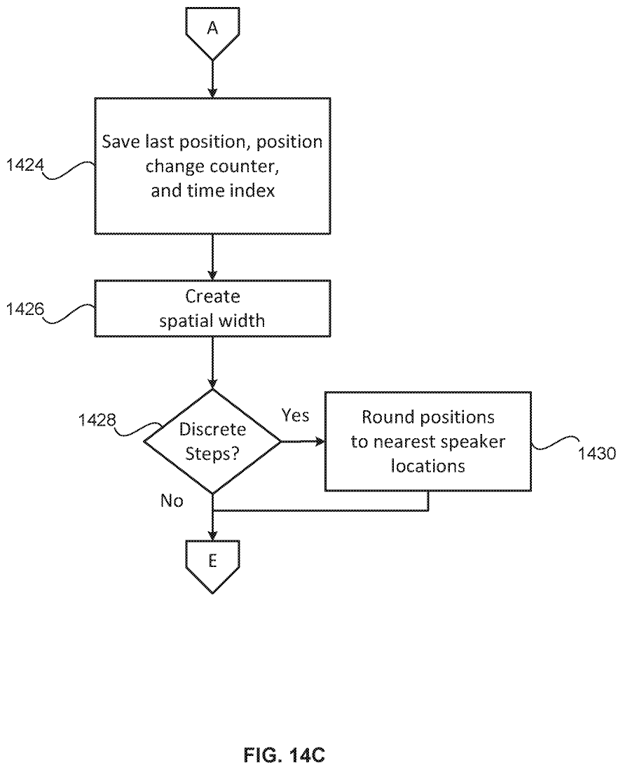

The software operation of the popcorn plugin or effect provided by the trajectory generator 220, 320 is summarized in the flowchart 1400 in FIG. 14A-14C. FIG. 14A-14C are a flow chart 1400 illustrating exemplary steps 1402-1430 performed by a trajectory generator 220, 320 for a popcorn plugin, in accordance with various embodiments. Referring to FIG. 14A, at step 1402, the trajectory generator 220, 320 is initialized. For example, the motion descriptors 1345 may be defined and set to default values 1355, the speaker layout and renderer information may be defined, applicable attributes (e.g., beats, onset, and the like) extracted from the input audio signals 110, 205, 305 may be defined, a buffer size may be set, and/or any suitable initializations. At step 1404, a buffer of the trajectory generator 220, 320 may be filled with samples of the audio input signal 110, 205, 305. For example, the steps 1404-1430 performed by the trajectory generator 220, 320 are implemented as a real-time loop to accept a buffer of audio input values and to output a buffer of audio and directional specification values to the renderer 130 for each buffer of audio input values. Once another input buffer is filled at step 1404, the user input control values 1355 are updated at step 1406. At step 1408, if the user has paused the motion, then the current position is held by filling the buffer with that value at step 1410 and the process 1400 proceeds to step 1424. If motion is not paused, the trajectory generator 220, 320 queries a position change counter to determine if it is time to change a random positioning of the sound at step 1412. If the trajectory generator 220, 320 determines it is not time for a position change, a position change counter is incremented at step 1418, a time index is incremented at step 1420, and if the end of the buffer has not yet been reached at step 1422, the process returns to step 1412 to determine if it is time for a position change.

If the trajectory generator 220, 320 determines it is time for a position change at step 1412, a new random position is selected at step 1414. The trajectory generator 220, 320 may be configured to randomly select the new position in a variety of manners. For example, in the exemplary embodiment of a circular array of eight speakers, a set of random permutations of integers one through eight could be created and iteratively used to select one speaker position out of the possible eight speaker positions. A new set may be created each time a set has been exhausted. After a new random position is selected at step 1414, the position counter is reset at step 1416, the position change counter is incremented at step 1418, and the time index is incremented at step 1420. Once the new buffer has been filled at step 1422, the process 1400 proceeds to step 1424 in FIG. 14C where the last position and time index is saved for when a new buffer is ready to be computed.

At step 1426, the desired spatial width is created, which corresponds with the trajectory signal in time synchronization with the audio signal. The desired spatial width (i.e., trajectory signal) defines position information in spherical polar coordinates over time. For the popcorn effect embodiment, the spatial width is changed by varying the number of virtual source positions depending on the desired width as described above for the position effect embodiment with respect to FIG. 6A-6B. If the trajectory generator 220, 320 determines that discrete steps was selected by the user via user interface 230, 300, 400 at step 1428, the trajectory generator 220, 320 rounds the position values to the nearest speaker locations at step 1430. The process 1400 then returns to step 1404 until the sampling of audio signal 110, 205, 305 is finished.

### Pulse Plugin

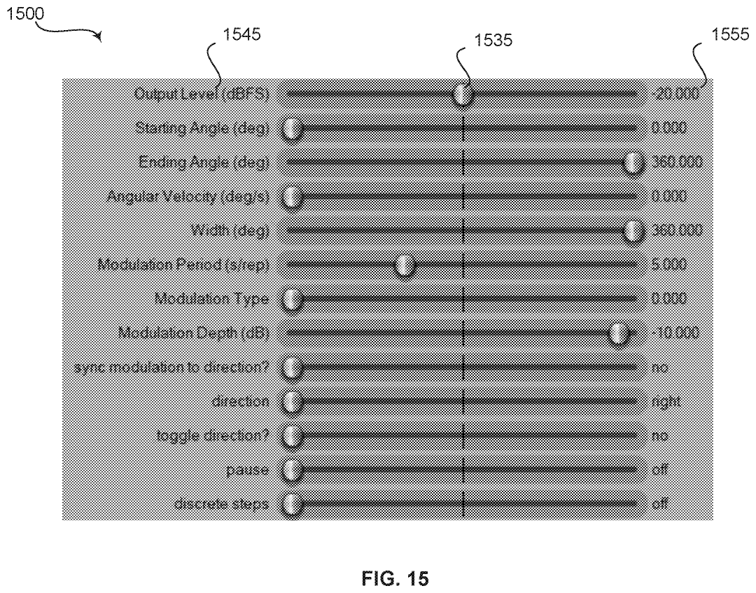

Another example of a dynamic sound manipulation is a “Pulse” plugin or effect. In this embodiment, the sound is manipulated to move in a circular or semi-circular pattern in the listening space similar to the twirl effect described above, but also provides amplitude modulation to the audio input 110, 205, 305. Accordingly, this pulse plugin embodiment illustrates how amplitude modulation may be added to other plugins described herein. The controls 235-1, 235-2, 235-N, 335 for this user interface 230, 330 may be configured to set input parameters of motion descriptors 245-1, 245-2, 245-N, 345, such as the starting and ending angle of the sound, an angular velocity of the sound, a width, and the like. An example user interface 1500 of controls 1535 for setting values 1555 of motion descriptors 1545 in a simplified two-dimensional implementation is shown in FIG. 15. FIG. 15 illustrates a screenshot of exemplary user interface controls for a two-dimensional implementation of a pulse plugin, in accordance with various embodiments. Referring to FIG. 15, sliders 1535, levers, or any suitable user interface element 1535 may be configured to control the relative output level in decibels (dB), the starting and ending angles in degrees, the angular velocity (degrees/second), sound width in degrees, modulation period (seconds/repetition), modulation depth (dB), and modulation type. Toggle-like controls are used to specify whether to synchronize the modulation to the directional movement, direction (clockwise or counter-clockwise in this simplified instance), whether to toggle the direction back and forth or one direction only, a motion pause, and whether the motion is continuous or jumps to and from each speaker. The beat extracted from the audio signals 110, 205, 305 by the attribute extractor 210, 310 may also be used by the trajectory generator 220, 320 in the pulse plugin to change rate from seconds per change to beats per change. Combining and synchronizing sound motion, sound modulation, and lighting and video effects can make for a compelling audience experience.

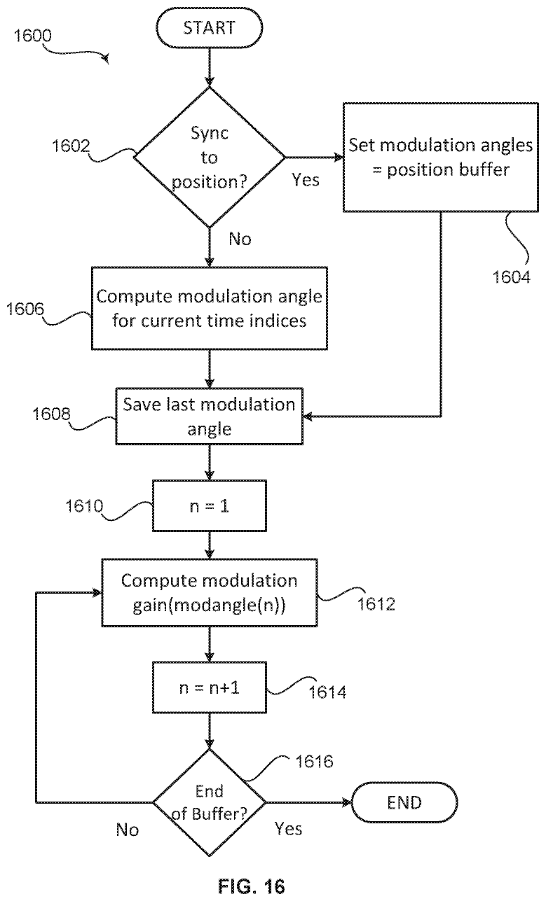

The trajectory generator 220, 320 in the particular instance of a pulse plugin or effect may be configured to apply equation 2 as described above with respect to the twirl plugin. Indeed, the software operation of the pulse plugin shares various characteristics with the twirl plugin described above with reference to FIG. 8A-8C. The primary difference is the addition of amplitude modulation prior to determining the spatial width as described with reference to FIG. 8C. The software operations for the amplitude modulation block are summarized in FIG. 16. FIG. 16 is a flow chart 1600 illustrating exemplary steps 1602-1616 that may be utilized for providing a gain modulation function of one or more plugins, such as a pulse plugin, in accordance with various embodiments. Referring to FIG. 16, at step 1602, the trajectory generator 220, 320 determines if the user has selected the synchronization to modulation mode. If so, the trajectory generator 220, 320 sets a buffer of modulation angles to be equal to the current buffer of position angle values at step 1604. If the trajectory generator 220, 320 determines the user has not selected the synchronization to modulation mode, then the trajectory generator 220, 320 computes a buffer of modulation angles for the current set of time indices at step 1606 by applying Equation 6:

modulation angle(t)=last modulation angle+modulation velocity*t; (6)

In Equation 6, t is time, last modulation angle is the last modulation input value between buffer computations, and modulation velocity is velocity in degrees per second. Thus, the trajectory generator 220, 320 maps the modulation angles around the unit circle between 0 and 360 degrees and repetitive modulations are created using periodic functions that use angle as an input. At step 1608, the last modulation angle is saved for the next iteration of audio input processing at step 1610. At step 1612, the modulation gain is computed for the set of modulation angles. The type of amplitude modulation can take various forms. For example, the stereo panning function, a one plus cosine function, a sawtooth waveform, and/or any suitable amplitude modulation may be performed. Regardless, the modulation depth is tested to set a floor for the minimum value. The set of modulation angles are incremented at step 1614 until the end of buffer at step 1616. Once the end of the buffer is reached at step 1616, the buffer of modulation gain values are applied by the gain adjust 225, 325 shown in FIGS. 2 and 3 and the spatial width gain values computed as shown in FIGS. 6A and 6B.

### Bumblebee Plugin

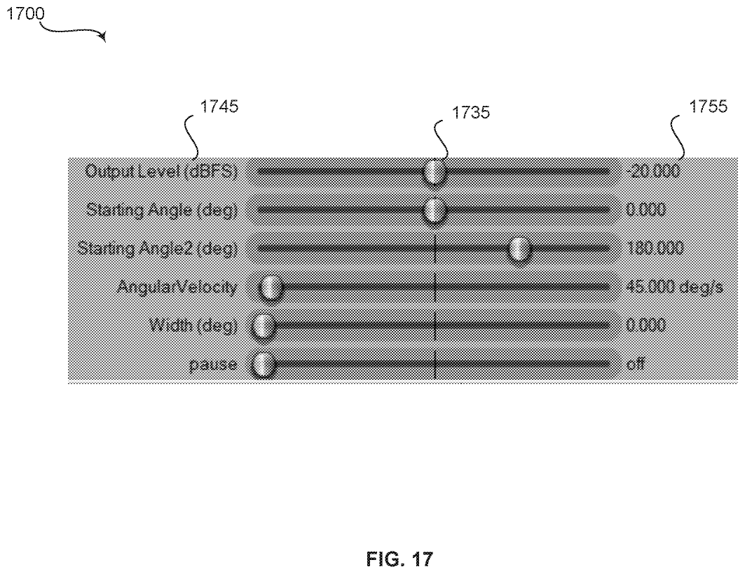

Another specific sound manipulation based on the framework shown in FIGS. 2 and 3 is a “Bumblebee” plugin or effect. In this embodiment, a sound moves in a random yet smooth path much like the flight of a bumblebee. The controls 235-1, 235-2, 235-N, 335 for this user interface 230, 330 may be configured to set input parameters of motion descriptors 245-1, 245-2, 245-N, 345, such as a starting angles, angular velocity, width, and the like. An example user interface 1700 of controls 1735 for setting values 1755 of motion descriptors 1745 in a simplified two-dimensional implementation is shown in FIG. 17. FIG. 17 illustrates a screenshot of exemplary user interface controls for a two-dimensional implementation of a bumblebee plugin, in accordance with various embodiments. Referring to FIG. 17, sliders 1735, levers, or any suitable user interface element 1735 may control the relative output level in decibels (dB), the starting angle in degrees, the velocity (degrees/second), and sound width in degrees, for example. In an exemplary embodiment, a toggle-like control may be used to specify whether to pause motion.

The trajectory generator 220, 320 in the particular instance of a bumblebee plugin may be configured to apply a random position generator to change to a new random sound object location. For example, the position equation may set forth the following:

position(t)=last position+random direction(t)*angular velocity*t; (7)

In Equation 7, t is time, last position is the last position value between buffer computations, random direction is a randomly chosen value of +1 or −1 specifying the direction of travel, and angular velocity is velocity in degrees per second. In an exemplary embodiment where rendering is applied by amplitude panning within a circular array of speakers, two independent instances of Equation 7 can be used to create a phantom image that randomly moves within the circle of the speakers. The output of the trajectory generator 220, 320 is also used to provide an animation of the sound motion at the graphic display 240, 340 in the user interface 230, 330. The width variable is like that used for the position plugin described above using a priori knowledge of the speaker locations.

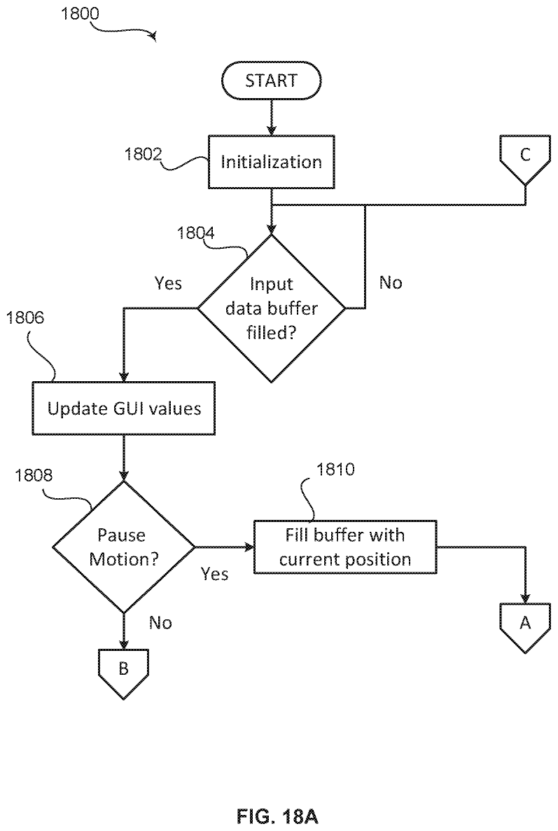

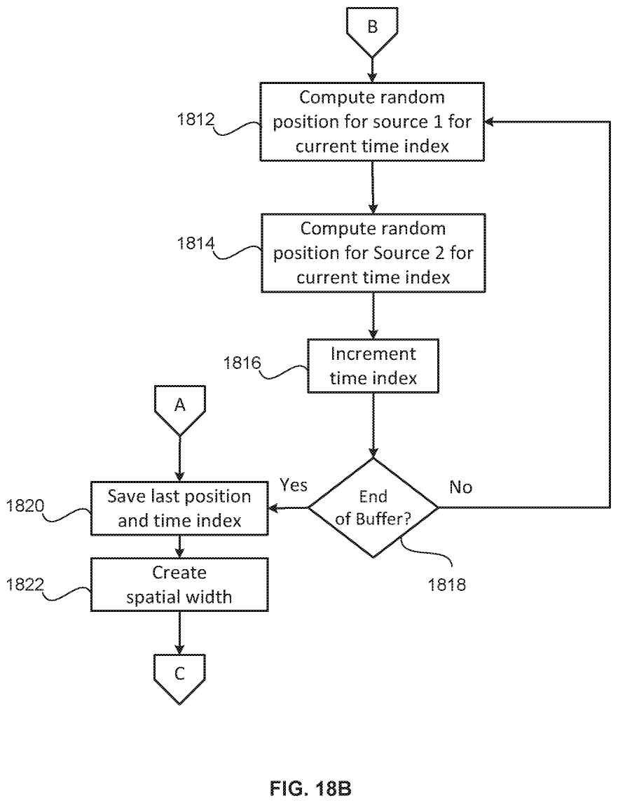

The software operation of the bumblebee plugin or effect provided by the trajectory generator 220, 320 is summarized in the flowchart 1800 in FIG. 18A-18B. FIG. 18A-18B are a flow chart 1800 illustrating exemplary steps 1802-1822 performed by a trajectory generator 220, 320 for a bumblebee plugin, in accordance with various embodiments. Referring to FIG. 18A, at step 1802, the trajectory generator 220, 320 is initialized. For example, the motion descriptors 1745 may be defined and set to default values 1755, the speaker layout and renderer information may be defined, applicable attributes (e.g., beats) extracted from the input audio signals 110, 205, 305 may be defined, a buffer size may be set, and/or any suitable initializations. At step 1804, a buffer of the trajectory generator 220, 320 may be filled with samples of the audio input signal 110, 205, 305. For example, the steps 1804-1822 performed by the trajectory generator 220, 320 are implemented as a real-time loop to accept a buffer of audio input values and to output a buffer of audio and directional specification values to the renderer 130 for each buffer of audio input values. Once another input buffer is filled at step 1804, the user input control values 1755 are updated at step 1806. At step 1808, if the user has paused the motion, then the current position is held by filling the buffer with that value at step 1810 and the process 1800 proceeds to step 1820. If motion is not paused, the trajectory generator 220, 320 computes the random position values one value at a time for each of the first and second sources at steps 1812 and 1814 using Equation 7 while incrementing the time index at step 1816 until the buffer is filled at step 1818. Once the buffer is filled at step 1818, the last position and time index is saved at step 1820 for when a new buffer is ready to be computed.

At step 1822, the desired spatial width is created, which corresponds with the trajectory signal in time synchronization with the audio signal. The desired spatial width (i.e., trajectory signal) defines position information in spherical polar coordinates over time. For the bumblebee effect embodiment, the spatial width is changed by varying the number of virtual source positions depending on the desired width as described above for the position effect embodiment with respect to FIG. 6A-6B. The process 1800 then returns to step 1804 until the sampling of audio signal 110, 205, 305 is finished.

### Other Plugins

Many other spatial motions can be conceived based on the framework shown in FIGS. 2 and 3. For example, a Curve Ball plugin or effect would create an arcing trajectory between endpoints like a baseball curve ball pitch. As another example, a Pipe Organ plugin or effect could map source pitches or Musical Instrument Digital Interface (MIDI) notes to specific locations in space creating a virtual pipe organ effect using any desired input sound. As another example, a Soundstage plugin could detect the musical instrument that produced the audio source signal and automatically place it in a suitable position in space. As another example, a Pond plugin could mimic the transient waves in a pond when a stone is thrown into the pond. Various embodiments may allow many other possibilities for combining custom GUI controls 235-1, 235-2, 235-N, 335 and trajectory generators 220, 320 to create compelling artistic experiences.

Aspects of the present disclosure provide a method 500, 800, 1000, 1200, 1400, 1600, 1800 and system 100, 200, 300 for providing spatial sound production tools operable to generate dynamically moving sounds. In accordance with various embodiments, the method 500, 800, 1000, 1200, 1400, 1600, 1800 may comprise receiving, by at least one processor 120, 200, 300 of an audio processing system 100, an audio signal 110, 205, 305. The method 500, 800, 1000, 1200, 1400, 1600, 1800 may comprise receiving, by the at least one processor 120, 200, 300, a user input 235-1, 235-2, 235-N, 335, 435, 735, 935, 1135, 1335, 1535, 1735 defining input parameters 455, 755, 955, 1155, 1355, 1555, 1755 of audio motion descriptors 245-1, 245-2, 245-N, 345, 445, 745, 945, 1145, 1345, 1545, 1745. The method 500, 800, 1000, 1200, 1400, 1600, 1800 may comprise processing, by the at least one processor 120, 200, 300, the input parameters 455, 755, 955, 1155, 1355, 1555, 1755 of the audio motion descriptors 245-1, 245-2, 245-N, 345, 445, 745, 945, 1145, 1345, 1545, 1745 to generate a trajectory signal 250, 350 in time synchronization with the audio signal 110, 205, 305. The trajectory signal 250, 350 defines position information in spherical polar coordinates over time. The method 500, 800, 1000, 1200, 1400, 1600, 1800 may comprise rendering, by the at least one processor 130, the audio signal 110, 205, 305 based on the trajectory signal 250, 350 to generate a rendered audio signal. The method 500, 800, 1000, 1200, 1400, 1600, 1800 may comprise outputting, by a sound system 140, the rendered audio signal as sound.

In an exemplary embodiment, the method 500, 800, 1000, 1200, 1400, 1600, 1800 may further comprise detecting, by the at least one processor 120, 200, 300, attributes of the audio signal 110, 205, 305. The input parameters 455, 755, 955, 1155, 1355, 1555, 1755 of the audio motion descriptors 245-1, 245-2, 245-N, 345, 445, 745, 945, 1145, 1345, 1545, 1745 are processed by the at least one processor 120, 200, 300 based on the attributes of the audio signal 110, 205, 305 to generate the trajectory signal 250, 350 in time synchronization with the audio signal 110, 205, 305. In a representative embodiment, the attributes of the audio signal 110, 205, 305 comprise an audio onset, an audio envelope, an audio pitch, and/or an audio beat. In various embodiments, the audio signal 110, 205, 305 comprises a prerecorded audio track stored in a WAV file, MPG file, or MIDI file. In certain embodiments, the audio signal 110, 205, 305 comprises a live audio signal received from a microphone and/or electronic instrument communicatively coupled to the audio system 100. In an exemplary embodiment, the sound system 150 comprises loudspeakers and/or headphones. In a representative embodiment, the trajectory signal 250, 350 defines a position effect that provides an expansion and/or contraction of a spatial width of the sound from a position in a listening space defined by the input parameters 455. The spatial width of the sound over time is defined by:

spatial width(t)=last width+width direction*width velocity*t;

wherein t is time, last width is a last width value between buffer computations, width direction is a value of +/−1 specifying whether the spatial width is expanding or contracting, and width velocity is velocity in degrees per second. In various embodiments, the trajectory signal 250, 350 defines a twirl effect that provides an effect of the sound moving in a circular or semi-circular pattern in a listening space. A position of the sound over time is defined by:

position(t)=last position+direction*angular velocity*t;

wherein t is time, last position is a last position value between buffer computations, direction is a value of +/−1 specifying a direction the sound is moving, and angular velocity is velocity in degrees per second. In certain embodiments, the trajectory signal 250, 350 defines a surf effect that provides an effect of the sound moving across a listening space along a line that mimics a portion of a wave on a surface of water. A line position of the sound over time is defined by:

line position(t)=last position+start offset+direction*starting angle*velocity*t;

wherein line position specifies a distance the sound has traveled along a line defined by a starting position and an ending position of the input parameters 955, t is time, last position is a last line position value between buffer computations, start offset is a starting position offset as a percentage of a distance between the starting position and the ending position, direction is a value of +/−1 specifying a travel direction of the sound, starting angle specifies starting position of the sound in degrees, and velocity is a line velocity in repetitions per second. In an exemplary embodiment, the trajectory signal 250, 350 defines a ping pong effect that provides an effect of the sound moving back and forth across a listening space along a line between two endpoints to mimic a volleying of a ping pong ball, wherein a position and spin angle of the sound over time is defined by:

position(t)=last position+direction*spin angle(t)*velocity*t;

where

spin angle(t)=last spin angle+spin direction*spin step;

wherein t is time, last position is a last position value between buffer computations, direction is a value of +/−1 specifying a travel direction of the sound, spin angle specifies line of travel in degrees, velocity is a velocity in repetitions per second, last spin angle is a last spin angle between buffer computations, spin direction is a value of +/−1 specifying a clockwise or counterclockwise rotation, and spin step a rotation amount after each repetition. In a representative embodiment, the trajectory signal 250, 350 defines a pulse effect that provides an effect of amplitude modulation of the sound as the sound moves in a listening space. A modulation angle of the sound over time is defined by:

modulation angle(t)=last modulation angle+modulation velocity*t;

wherein t is time, last modulation angle is a last modulation input value between buffer computations, and modulation velocity is a velocity in degrees per second. In various embodiments, the trajectory signal 250, 350 defines a bumblebee effect that provides an effect of the sound moving in a random, smooth path mimicking a flight of a bumblebee. A position of the sound over time is defined by:

position(t)=last position+random direction(t)*angular Velocity*t;

wherein t is time, last position is a last position value between buffer computations, random direction is a randomly chosen value of +1 or −1 specifying a direction of travel, and angular velocity is a velocity in degrees per second. In certain embodiments, the trajectory signal 250, 350 defines a popcorn effect that positions the sound at different randomly selected positions over time.

Various embodiments provide a system 100, 200, 300 for providing spatial sound production tools operable to generate dynamically moving sounds. The system 100, 200, 300 may comprise at least one processor 120, 130, 200, 300 and a sound system 140. The at least one processor 120, 200, 300 may be configured to receive an audio signal 110, 205, 305. The at least one processor 120, 200, 300 may be configured to receive a user input 235-1, 235-2, 235-N, 335, 435, 735, 935, 1135, 1335, 1535, 1735 defining input parameters 455, 755, 955, 1155, 1355, 1555, 1755 of audio motion descriptors 245-1, 245-2, 245-N, 345, 445, 745, 945, 1145, 1345, 1545, 1745. The at least one processor 120, 200, 300 may be configured to process the input parameters 455, 755, 955, 1155, 1355, 1555, 1755 of the audio motion descriptors 245-1, 245-2, 245-N, 345, 445, 745, 945, 1145, 1345, 1545, 1745 to generate a trajectory signal 250, 350 in time synchronization with the audio signal 110, 205, 305. The trajectory signal 250, 350 defines position information in spherical polar coordinates over time. The at least one processor 130 may be configured to render the audio signal 110, 205, 305 based on the trajectory signal 250, 350 to generate a rendered audio signal. The sound system 140 may be configured to output the rendered audio signal as sound.

In a representative embodiment, the at least one processor 120, 200, 300 is configured to detect attributes of the audio signal 110, 205, 305. The input parameters 455, 755, 955, 1155, 1355, 1555, 1755 of the audio motion descriptors 245-1, 245-2, 245-N, 345, 445, 745, 945, 1145, 1345, 1545, 1745 are processed by the at least one processor 120, 200, 300 based on the attributes of the audio signal 110, 205, 305 to generate the trajectory signal 250, 350 in time synchronization with the audio signal 110, 205, 305. In various embodiments, the attributes of the audio signal 110, 205, 305 comprise an audio onset, an audio envelope, an audio pitch, and/or an audio beat. In certain embodiments, the audio signal 110, 205, 305 comprises a prerecorded audio track stored in a WAV file, MPG file, or MIDI file. In an exemplary embodiment, the audio signal 110, 205, 305 comprises a live audio signal received from a microphone and/or electronic instrument communicatively coupled to the audio system 100. In a representative embodiment, the sound system 140 comprises loudspeakers and/or headphones. In various embodiments, the trajectory signal 250, 350 defines a position effect that provides an expansion and/or contraction of a spatial width of the sound from a position in a listening space defined by the input parameters 455. The spatial width of the sound over time is defined by:

spatial width(t)=last width+width direction*width velocity*t;

wherein t is time, last width is a last width value between buffer computations, width direction is a value of +/−1 specifying whether the spatial width is expanding or contracting, and width velocity is velocity in degrees per second. In certain embodiments, the trajectory signal 250, 350 defines a twirl effect that provides an effect of the sound moving in a circular or semi-circular pattern in a listening space. A position of the sound over time is defined by:

position(t)=last position+direction*angular velocity*t;

wherein t is time, last position is a last position value between buffer computations, direction is a value of +/−1 specifying a direction the sound is moving, and angular velocity is velocity in degrees per second. In an exemplary embodiment, the trajectory signal 250, 350 defines a surf effect that provides an effect of the sound moving across a listening space along a line that mimics a portion of a wave on a surface of water. A line position of the sound over time is defined by:

line position(t)=last position+start offset+direction*starting angle*velocity*t;

wherein line position specifies a distance the sound has traveled along a line defined by a starting position and an ending position of the input parameters 955, t is time, last position is a last line position value between buffer computations, start offset is a starting position offset as a percentage of a distance between the starting position and the ending position, direction is a value of +/−1 specifying a travel direction of the sound, starting angle specifies starting position of the sound in degrees, and velocity is a line velocity in repetitions per second. In a representative embodiment, the trajectory signal 250, 350 defines a ping pong effect that provides an effect of the sound moving back and forth across a listening space along a line between two endpoints to mimic a volleying of a ping pong ball. A position and spin angle of the sound over time is defined by:

position(t)=last position+direction*spin angle(t)*velocity*t;

where

spin angle(t)=last spin angle+spin direction*spin step;

wherein t is time, last position is a last position value between buffer computations, direction is a value of +/−1 specifying a travel direction of the sound, spin angle specifies line of travel in degrees, velocity is a velocity in repetitions per second, last spin angle is a last spin angle between buffer computations, spin direction is a value of +/−1 specifying a clockwise or counterclockwise rotation, and spin step a rotation amount after each repetition. In various embodiments, the trajectory signal 250, 350 defines a pulse effect that provides an effect of amplitude modulation of the sound as the sound moves in a listening space. A modulation angle of the sound over time is defined by:

modulation angle(t)=last modulation angle+modulation velocity*t;

wherein t is time, last modulation angle is a last modulation input value between buffer computations, and modulation velocity is a velocity in degrees per second. In certain embodiments, the trajectory signal 250, 350 defines a bumblebee effect that provides an effect of the sound moving in a random, smooth path mimicking a flight of a bumblebee. A position of the sound over time is defined by:

position(t)=last position+random direction(t)*angular velocity*t;

wherein t is time, last position is a last position value between buffer computations, random direction is a randomly chosen value of +1 or −1 specifying a direction of travel, and angular velocity is a velocity in degrees per second. In an exemplary embodiment, the trajectory signal 250, 350 defines a popcorn effect that positions the sound at different randomly selected positions over time.

As utilized herein the term “circuitry” refers to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or.” As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” and/or “configured” to perform a function whenever the circuitry comprises the necessary hardware and code (if any is necessary) to perform the function, regardless of whether performance of the function is disabled, or not enabled, by some user-configurable setting.

Other embodiments may provide a computer readable device and/or a non-transitory computer readable medium, and/or a machine readable device and/or a non-transitory machine readable medium, having stored thereon, a machine code and/or a computer program having at least one code section executable by a machine and/or a computer, thereby causing the machine and/or computer to perform the steps as described herein for providing spatial sound production tools operable to generate dynamically moving sounds.

Accordingly, the present disclosure may be realized in hardware, software, or a combination of hardware and software. The present disclosure may be realized in a centralized fashion in at least one computer system, or in a distributed fashion where different elements are spread across several interconnected computer systems. Any kind of computer system or other apparatus adapted for carrying out the methods described herein is suited.

Various embodiments may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed.

What is claimed is:

1. A method, comprising:
receiving, by at least one processor of an audio processing system, an audio signal;
receiving, by the at least one processor, a user input defining input parameters of audio motion descriptors;
processing, by the at least one processor, the input parameters of the audio motion descriptors to generate a trajectory signal in time synchronization with the audio signal, wherein the trajectory signal defines position information in spherical polar coordinates over time;
rendering, by the at least one processor, the audio signal based on the trajectory signal to generate a rendered audio signal; and
outputting, by a sound system, the rendered audio signal as sound.

2. The method of claim 1, further comprising detecting, by the at least one processor, attributes of the audio signal, wherein the input parameters of the audio motion descriptors are processed by the at least one processor based on the attributes of the audio signal to generate the trajectory signal in time synchronization with the audio signal.

3. The method of claim 2, wherein the attributes of the audio signal comprise:
an audio onset;
an audio envelope;
an audio pitch; and/or
an audio beat.

4. The method of claim 1, wherein the audio signal comprises a prerecorded audio track stored in a WAV file, MPG file, or MIDI file.

5. The method of claim 1, wherein the audio signal comprises a live audio signal received from a microphone and/or electronic instrument communicatively coupled to the audio system.

6. The method of claim 1, wherein the sound system comprises loudspeakers and/or headphones.

7. The method of claim 1, wherein the trajectory signal defines a position effect that provides an expansion and/or contraction of a spatial width of the sound from a position in a listening space defined by the input parameters, wherein the spatial width of the sound over time is defined by:
spatial width(t)=last width+width direction*width velocity*t;
wherein t is time, last width is a last width value between buffer computations, width direction is a value of +/−1 specifying whether the spatial width is expanding or contracting, and width velocity is velocity in degrees per second.

8. The method of claim 1, wherein the trajectory signal defines a twirl effect that provides an effect of the sound moving in a circular or semi-circular pattern in a listening space, wherein a position of the sound over time is defined by:
position(t)=last position+direction*angular velocity*t;
wherein t is time, last position is a last position value between buffer computations, direction is a value of +/−1 specifying a direction the sound is moving, and angular velocity is velocity in degrees per second.

9. The method of claim 1, wherein the trajectory signal defines a surf effect that provides an effect of the sound moving across a listening space along a line that mimics a portion of a wave on a surface of water, wherein a line position of the sound over time is defined by:
line position(t)=last position+start offset+direction*starting angle*velocity*t;
wherein line position specifies a distance the sound has traveled along a line defined by a starting position and an ending position of the input parameters, t is time, last position is a last line position value between buffer computations, start offset is a starting position offset as a percentage of a distance between the starting position and the ending position, direction is a value of +/−1 specifying a travel direction of the sound, starting angle specifies starting position of the sound in degrees, and velocity is a line velocity in repetitions per second.

10. The method of claim 1, wherein the trajectory signal defines a ping pong effect that provides an effect of the sound moving back and forth across a listening space along a line between two endpoints to mimic a volleying of a ping pong ball, wherein a position and spin angle of the sound over time is defined by:
position(t)=last position+direction*spin angle(t)*velocity*t;
where
spin angle(t)=last spin angle+spin direction*spin step;
wherein t is time, last position is a last position value between buffer computations, direction is a value of +/−1 specifying a travel direction of the sound, spin angle specifies line of travel in degrees, velocity is a velocity in repetitions per second, last spin angle is a last spin angle between buffer computations, spin direction is a value of +/−1 specifying a clockwise or counterclockwise rotation, and spin step a rotation amount after each repetition.

11. The method of claim 1, wherein the trajectory signal defines a pulse effect that provides an effect of amplitude modulation of the sound as the sound moves in a listening space, wherein a modulation angle of the sound over time is defined by:
modulation angle(t)=last modulation angle+modulation velocity*t;
wherein t is time, last modulation angle is a last modulation input value between buffer computations, and modulation velocity is a velocity in degrees per second.

12. The method of claim 1, wherein the trajectory signal defines a bumblebee effect that provides an effect of the sound moving in a random, smooth path mimicking a flight of a bumblebee, wherein a position of the sound over time is defined by:
position(t)=last position+random direction(t)*angular velocity*t;
wherein t is time, last position is a last position value between buffer computations, random direction is a randomly chosen value of +1 or −1 specifying a direction of travel, and angular velocity is a velocity in degrees per second.

13. The method of claim 1, wherein the trajectory signal defines a popcorn effect that positions the sound at different randomly selected positions over time.

14. An audio system, comprising:
at least one processor configured to:
receive an audio signal,
receive a user input defining input parameters of audio motion descriptors;
process the input parameters of the audio motion descriptors to generate a trajectory signal in time synchronization with the audio signal, wherein the trajectory signal defines position information in spherical polar coordinates over time; and
render the audio signal based on the trajectory signal to generate a rendered audio signal; and
a sound system configured to output the rendered audio signal as sound.

15. The audio system of claim 14, wherein:
the at least one processor is configured to detect attributes of the audio signal; and
the input parameters of the audio motion descriptors are processed by the at least one processor based on the attributes of the audio signal to generate the trajectory signal in time synchronization with the audio signal.

16. The audio system of claim 15, wherein the attributes of the audio signal comprise:
an audio onset;
an audio envelope;
an audio pitch; and/or
an audio beat.

17. The audio system of claim 14, wherein the audio signal comprises a prerecorded audio track stored in a WAV file, MPG file, or MIDI file.

18. The audio system of claim 14, wherein the audio signal comprises a live audio signal received from a microphone and/or electronic instrument communicatively coupled to the audio system.

19. The audio system of claim 14, wherein the sound system comprises loudspeakers and/or headphones.

20. The audio system of claim 14, wherein the trajectory signal defines a position effect that provides an expansion and/or contraction of a spatial width of the sound from a position in a listening space defined by the input parameters, wherein the spatial width of the sound over time is defined by:
spatial width(t)=last width+width direction*width velocity*t;
wherein t is time, last width is a last width value between buffer computations, width direction is a value of +/−1 specifying whether the spatial width is expanding or contracting, and width velocity is velocity in degrees per second.

21. The audio system of claim 14, wherein the trajectory signal defines a twirl effect that provides an effect of the sound moving in a circular or semi-circular pattern in a listening space, wherein a position of the sound over time is defined by:
position(t)=last position+direction*angular velocity*t;
wherein t is time, last position is a last position value between buffer computations, direction is a value of +/−1 specifying a direction the sound is moving, and angular velocity is velocity in degrees per second.

22. The audio system of claim 14, wherein the trajectory signal defines a surf effect that provides an effect of the sound moving across a listening space along a line that mimics a portion of a wave on a surface of water, wherein a line position of the sound over time is defined by:
line position(t)=last position+start offset+direction*starting angle*velocity*t;
wherein line position specifies a distance the sound has traveled along a line defined by a starting position and an ending position of the input parameters, t is time, last position is a last line position value between buffer computations, start offset is a starting position offset as a percentage of a distance between the starting position and the ending position, direction is a value of +/−1 specifying a travel direction of the sound, starting angle specifies starting position of the sound in degrees, and velocity is a line velocity in repetitions per second.

23. The audio system of claim 14, wherein the trajectory signal defines a ping pong effect that provides an effect of the sound moving back and forth across a listening space along a line between two endpoints to mimic a volleying of a ping pong ball, wherein a position and spin angle of the sound over time is defined by:
position(t)=last position+direction*spin angle(t)*velocity*t;
where
spin angle(t)=last spin angle+spin direction*spin step;
wherein t is time, last position is a last position value between buffer computations, direction is a value of +/−1 specifying a travel direction of the sound, spin angle specifies line of travel in degrees, velocity is a velocity in repetitions per second, last spin angle is a last spin angle between buffer computations, spin direction is a value of +/−1 specifying a clockwise or counterclockwise rotation, and spin step a rotation amount after each repetition.

24. The audio system of claim 14, wherein the trajectory signal defines a pulse effect that provides an effect of amplitude modulation of the sound as the sound moves in a listening space, wherein a modulation angle of the sound over time is defined by:
modulation angle(t)=last modulation angle+modulation velocity*t;
wherein t is time, last modulation angle is a last modulation input value between buffer computations, and modulation velocity is a velocity in degrees per second.

25. The audio system of claim 14, wherein the trajectory signal defines a bumblebee effect that provides an effect of the sound moving in a random, smooth path mimicking a flight of a bumblebee, wherein a position of the sound over time is defined by:
position(t)=last position+random direction(t)*angular velocity*t;
wherein t is time, last position is a last position value between buffer computations, random direction is a randomly chosen value of +1 or −1 specifying a direction of travel, and angular velocity is a velocity in degrees per second.

26. The audio system of claim 14, wherein the trajectory signal defines a popcorn effect that positions the sound at different randomly selected positions over time.
